(19) United States
(12) Patent Application Publication
(10) Pub. No.: US 2010/0266297 A1
(43) Pub. Date: Oct. 21, 2010

(54) IMAGE FORMING APPARATUS AND IMAGE CARRIER UNIT

(75) Inventors: Seiko ITAGAKI, Tokyo (JP); Hiroshi AKITA, Tokyo (JP); Hiroyuki SAITO, Tokyo (JP); Natsuko MINEGISHI, Tokyo (JP)

Correspondence Address: CANTOR COLBURN, LLP, 20 Church Street, 22nd Floor, Hartford, CT, 06103, US

(73) Assignee: Konica Minolta Business Technologies, Inc., Tokyo (JP)

(21) Appl. No.: 12/760,830

(22) Filed: Apr. 15, 2010

(30) Foreign Application Priority Data
Apr. 17, 2009 (JP) 2009-100651
Apr. 21, 2009 (JP) 2009-102646

(51) Int. Cl. G03G 15/08

(52) U.S. Cl. 399/30

(57) ABSTRACT

Disclosed is an image forming apparatus including a toner reallocation electrode to carry out a reallocation of a toner of a toner image, a toner detection section to detect a toner amount of the toner image and a control section to calculate a toner amount adhered to the toner reallocation electrode or a density distribution of the toner image based on the detected toner amount and to control an AC component of an applied voltage based on the calculated toner amount or density distribution, and the control section decides a maximum value of the AC component of the applied voltage based on the toner amount or decides a minimum value of the AC component of the applied voltage based on the density distribution, and the control section controls the AC component within a control range of smaller than or equal to the decided maximum value or greater than or equal to the decided minimum value.

### BACKGROUND OF THE INVENTION

1. Field of the Invention

The present invention relates to an image forming apparatus and an image carrier unit.

2. Description of Related Art

In an image forming process, a development device develops a latent image formed on a photoreceptor as a toner image. In the development device, a magnetic brush is formed when developing the latent image as a toner image and tip of the formed magnetic brush is made to contact the photoreceptor.

Here, due to the contacting of magnetic brush or the like, a rough toner image with bad graininess will be developed on the photoreceptor. In particular, a toner image with brush-mark condition is developed, and this is especially prominently manifested in a halftone image. Here, it is confirmed that the brush-mark occurs not only in a two-component development method which forms the magnetic brush but also occurs in a magnetic one-component development method.

Further, an excessive density part which is called a swept-up occurs in a downstream of the development roller rotation direction due to the operation of the magnetic brush.

There is disclosed a development device in which an electrode is provided more in a downstream side of the photoreceptor than the development section and which reallocates the once developed toner to an appropriate position by making the toner reciprocate between the photoreceptor and the electrode in order to remove the brush-mark and the swept-up (JP H4-372964).

Further, there is disclosed a technique to apply an appropriate voltage to the electrode so that toner will not adhere to the electrode during the reciprocal movement (JP H6-274040).

However, in the techniques of JP H4-372964 and JP H6-274040, there is a possibility that toner adheres to the electrode depending on setting environment and frequency of usage of the development device. When the amount of toner which adheres to the electrode becomes greater, the effect of toner reallocation becomes small because the electric field between the electrode and the photoreceptor becomes weak, and image quality is deteriorated as a result. It is preferred to apply low voltage of a level where toner does not adhere to the electrode, however, toner will not carry out the reciprocal movement between the electrode and the photoreceptor when the applied voltage is too low, and similarly to the case described above, the effect of toner reallocation becomes small and image quality is deteriorated.

Moreover, in the techniques of JP H4-372964 and JP H6-274040, adhesion of toner to the electrode cannot be confirmed and there is no action suggested for a removing section in a case if the toner is adhered to the electrode.

### SUMMARY OF THE INVENTION

An object of the present invention is to provide an image forming apparatus in which toner does not adhere to the electrode and which decides the voltage value to be applied to the toner reallocation electrode after setting a range for the applying voltage value in which the effect of toner reallocation can be obtained.

Further, another object of the present invention is to provide an image forming apparatus and an image carrier unit which effectively controls the adhesion of toner to the toner reallocation electrode and which can prevent deterioration of image quality by removing the toner when the toner adheres to the toner reallocation electrode.

According to a first aspect of the present invention, there is provided an image forming apparatus comprising a toner reallocation electrode to carry out a reallocation of a toner of a toner image by applying an electric field to the toner image developed on a latent image carrier which moves, a toner detection section to detect a toner amount of the toner image developed on the latent image carrier and a control section to calculate a toner amount adhered to the toner reallocation electrode or a density distribution of the toner image developed on the latent image carrier based on the toner amount detected by the toner detection section and to control an AC component of an applied voltage to be applied to the toner reallocation electrode based on the calculated toner amount or the calculated density distribution, and the control section decides a maximum value of the AC component of the applied voltage based on the toner amount or decides a minimum value of the AC component of the applied voltage based on the density distribution, and the control section controls the AC component within a control range of smaller than or equal to the decided maximum value or greater than or equal to the decided minimum value.

According to a second aspect of the present invention, there is provided an image forming apparatus comprising a toner reallocation electrode to carry out a reallocation of a toner of a toner image by applying an electric field to the toner image developed on a latent image carrier which moves, a toner detection section to detect a toner amount of the toner image developed on the latent image carrier and a control section to calculate a toner amount adhered to the toner reallocation electrode or a density distribution of the toner image developed on the latent image carrier based on the toner amount detected by the toner detection section and to control an AC component or a DC component of an applied voltage to be applied to the toner reallocation electrode based on the calculated toner amount or the calculated density distribution.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a schematic diagram of an image forming apparatus;

FIG. 2 is a schematic cross-sectional diagram of a toner reallocation unit;

FIG. 3 is a schematic cross-sectional diagram of an IDC sensor;

FIG. 4 is a diagram showing an example of patch images;

FIGS. 5A and 5B are diagrams showing relations between input value of IDC sensor and amount of toner adhered on a photoreceptor;

FIG. 6 is a diagram showing a relation between input value of IDC sensor and position in secondary scanning direction;

FIG. 7 is a diagram showing a relation between input value of IDC sensor and position in secondary scanning direction;

FIG. 8 is a diagram showing a relation between input value of IDC sensor and position in secondary scanning direction;

FIG. 9 is a flowchart showing an electrode condition setting curtailing process;

FIGS. 10A and 10B are a flowchart showing the first electrode condition setting process;

FIG. 11 is a schematic diagram of the first electrode condition setting process;

FIG. 12 is a flowchart showing the second electrode condition setting process;

FIG. 13 is a schematic diagram of the second electrode condition setting process;

FIG. 14 is a flowchart showing the third electrode condition setting process;

FIG. 15 is a schematic diagram of the third electrode condition setting process;

FIG. 16 is a flowchart showing the fourth electrode condition setting process;

FIG. 17 is a schematic diagram of the fourth electrode condition setting process;

FIG. 18 is a diagram showing an example of a criteria table;

FIG. 19 is a flowchart showing the first time shortening process;

FIG. 20 is a flowchart showing the second time shortening process;

FIG. 21 is a diagram showing an example of a patch image;

FIG. 22 is a diagram showing a relation between input value of IDC sensor and position in secondary scanning direction;

FIG. 23 is a flowchart showing the fifth electrode condition setting process;

FIG. 24 is a flowchart showing the sixth electrode condition setting process; and

FIG. 25 is a flowchart showing the seventh electrode condition setting process.

### DESCRIPTION OF THE PREFERRED EMBODIMENTS

### First Embodiment

Structure and operation of an image forming apparatus according to the first embodiment will be described in detail with reference to the diagrams. Here, the structure and operation of the first embodiment is an example of the present invention, and the present invention is not limited to this.

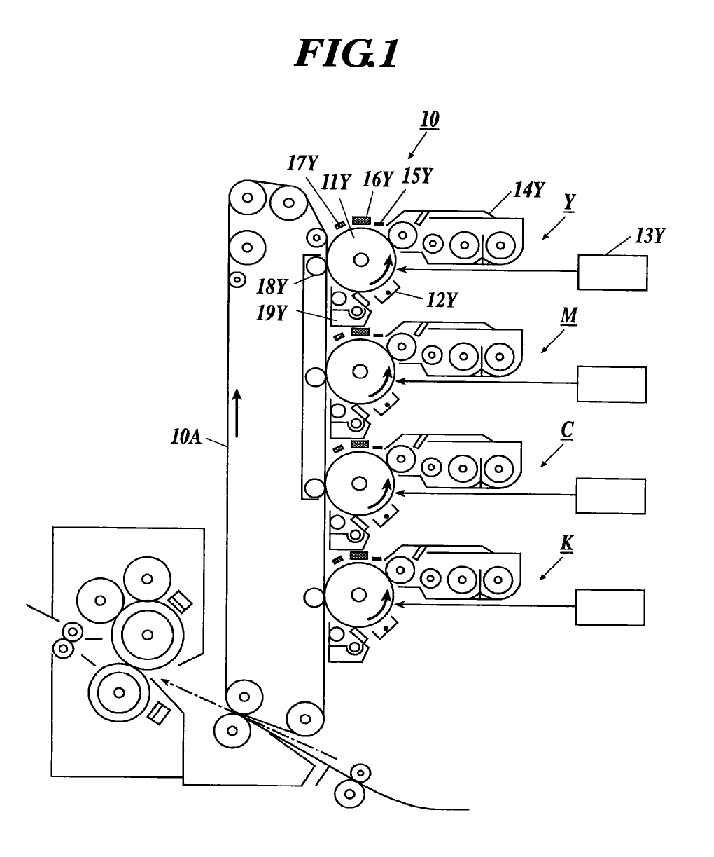

In FIG. 1, a schematic diagram of an image forming apparatus 10 is shown.

The image forming apparatus 10 comprises a yellow imaging section Y, a magenta imaging section M, a cyan imaging section C and a black imaging section K. Each of the imaging sections Y, M, C and K is provided along a traveling direction of an intermediate transfer body 10A.

The yellow imaging section Y comprises a charging device 12Y, an exposure device 13Y, a development device 14Y, a cleaning pad 15Y, a toner reallocation electrode 16Y, IDC (Image Density Control) sensor 17Y as a toner detection section, a transfer roller 18Y and a cleaning device 19Y at the periphery of a photoreceptor 11Y which is in a drum shape.

The yellow imaging section Y forms a yellow toner image on the photoreceptor 11Y by using the above mentioned each of the devices (12Y to 19Y) and transfers the formed toner image to the intermediate transfer body 10A.

The magenta imaging section M, the cyan imaging section C and the black imaging section K have structures and operations similar to the above described structure and operation of the yellow imaging section Y. Therefore, descriptions will be omitted here.

Hereinafter, description will be given by taking the yellow imaging section Y as an example.

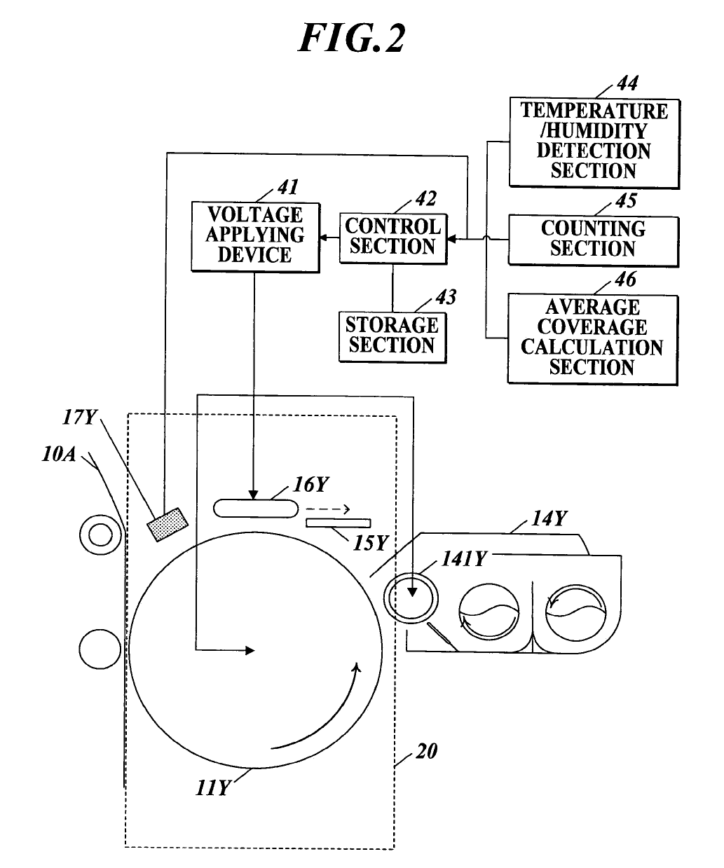

In FIG. 2, an image carrier unit 20 is shown.

The image carrier unit 20 comprises at least the photoreceptor 11Y, the toner reallocation electrode 16Y and the IDC sensor 17Y in a casing which structures the image forming apparatus 10. Further, it is preferred to comprise the cleaning pad 15Y.

The cleaning pad 15Y removes toner adhered to the surface of the toner reallocation electrode 16Y. At the time of toner removal, the toner reallocation electrode 16Y moves in a direction of the cleaning pad 15Y and surfaces of the cleaning pad 15Y and the toner reallocation electrode 16Y scrape against each other.

As another embodiment example of the toner removal, there is a method of switching the voltage applied to the toner reallocation electrode 16Y between at the time of toner reallocation operation and at the time of toner removal.

In particular, the applied voltage of DC component of the toner reallocation electrode 16Y is set to −600V at the time of toner reallocation and is set to −1000V at the time of toner removal, for example. The applied voltage of AC component is set to 2.5 kV in both cases and the frequency is set to 9 kHz in both cases.

When the applied voltage of DC component is switched to −1000V from −600V, a stronger electric field is formed in a direction of the photoreceptor 11Y from the toner reallocation electrode 16Y.

The toner adhered to the surface of the toner reallocation electrode 16Y is blown in the direction of the photoreceptor 11Y. In such way, the toner of the electrode surface can be removed. The toner which moved to the photoreceptor 11Y can be removed by the cleaning device 19Y of the photoreceptor 11Y.

The toner reallocation electrode 16Y carries out the above described voltage switching operation in a non-image area at the time of printing to constantly clean the electrode surface. When only a small amount of toner is adhered to the electrode, the voltage switching operation is effective. The toner removal may be carried out by using both the cleaning pad 15Y and the voltage switching operation.

The toner reallocation electrode 16Y is provided more in a downstream side of a rotating direction of the photoreceptor 11Y than the development device 14Y and is disposed close to the photoreceptor 11Y so as to face the photoreceptor 11Y.

Regarding the structure of the toner reallocation electrode 16Y and other peripheral structures, an example is shown in the following table 1. Here, the present invention is not limited to this example.

TABLE 1
<Structure of Toner Reallocation Electrode>

| | |
|---|---|
| Length of main scanning direction: | 310 mm |
| Length of secondary scanning direction: | 15 mm |
| Thickness of electrode: | 15 mm |
| Material: | aluminum |
| Roughness of electrode surface (Rz): | 0.8 μm |
| Distance between electrode and photoreceptor: | 0.3 mm |
| Applied voltage (DC component): | −600 V |
| Applied voltage (AC component): | 2.5 kV, 9 kHz |

<Other structure>

| | |
|---|---|
| Diameter of photoreceptor: | 60 mm |
| Process speed: | 400 mm/s |

The toner reallocation electrode 16Y is connected to the voltage applying device 41.

The toner reallocation electrode 16Y forms an electric field near the surface according to the voltage of DC component or AC component applied by the voltage applying device 41 (hereinafter, the voltages are called “DC bias” and “AC bias” and they are called “bias voltage” together).

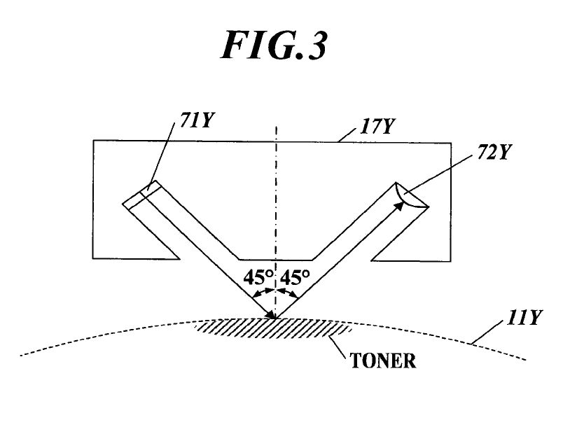

In FIG. 3, a schematic cross-sectional diagram of the IDC sensor 17Y is shown.

The IDC sensor 17Y comprises a light emitting element 71Y and a light receiving element 72Y, and the IDC sensor 17Y is disposed so as to face the photoreceptor 11Y.

The light emitting element 71Y is structured of an LED in which the emission center wavelength is 780 [nm].

The light receiving element 72Y is structured of a photodiode.

The IDC sensor 17Y irradiates an infrared light (irradiation light) to the surface of the photoreceptor 11Y by the light emitting element 71Y and receives the reflection light of the infrared light which is reflected at the surface of the photoreceptor 11Y by the light receiving element 72Y.

The IDC sensor 17Y is structured so as to only receive the reflection light of 45° angle among the reflection light which diffusely reflects at the surface of the photoreceptor 11Y.

Returning to FIG. 2, the voltage applying device 41 applies DC bias to the photoreceptor 11Y and the development roller 141Y and applies DC bias and AC bias to the toner reallocation electrode 16Y by the control of the control section 42.

The control section 42 decides the bias voltage value to be applied to the toner reallocation electrode 16Y by the voltage applying device 41 by cooperating with various types of programs stored in the storage section 43.

Moreover, the control section 42 inputs various types of data outputted from a temperature/humidity detection unit 44, a counting section 45 or an average coverage calculation section 46 and decides the bias voltage value based on the inputted data.

The storage section 43 is structured of a RAM, a ROM or the like, and the storage section 43 stores various types of programs, data obtained by executing the programs and the like.

The temperature/humidity detection section 44 detects temperature or humidity and outputs data relating to the detected temperature or humidity to the control section 42.

The counting section 45 calculates the number of prints in a period between a predetermined previous print and the immediate print and outputs data regarding the calculated number of prints to the control section 42.

The average coverage calculation section 46 calculates the average coverage of a period between a predetermined previous print and the immediate print and outputs data relating to the calculated average coverage to the control section 42.

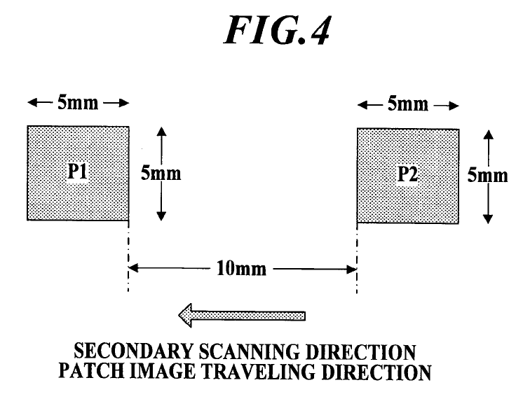

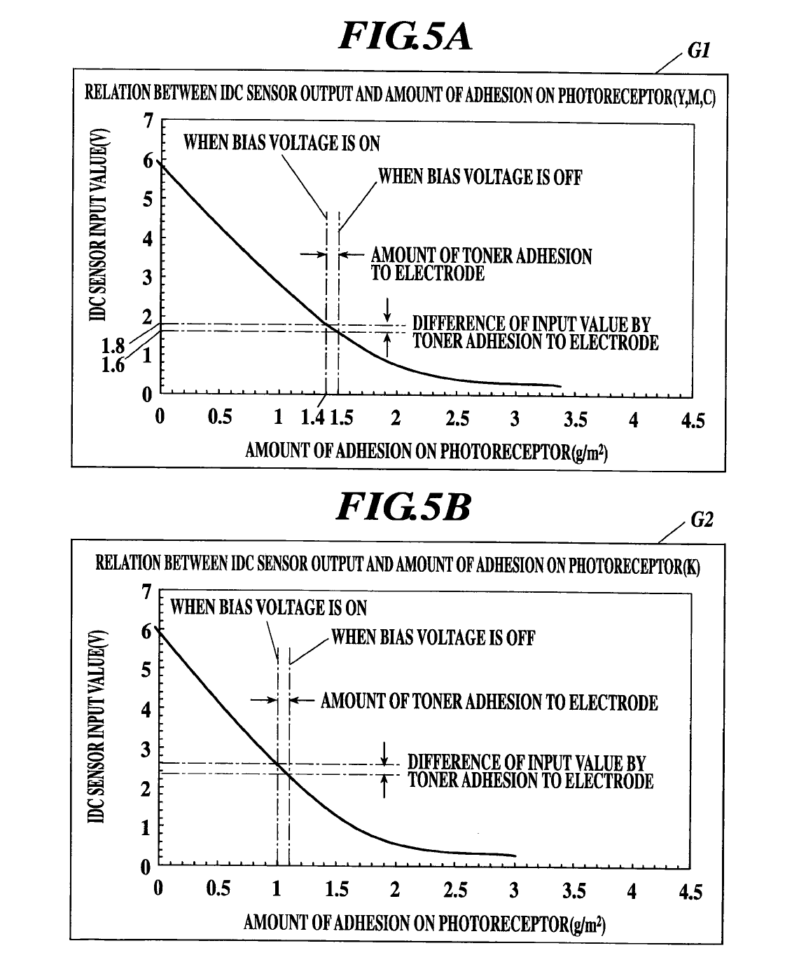

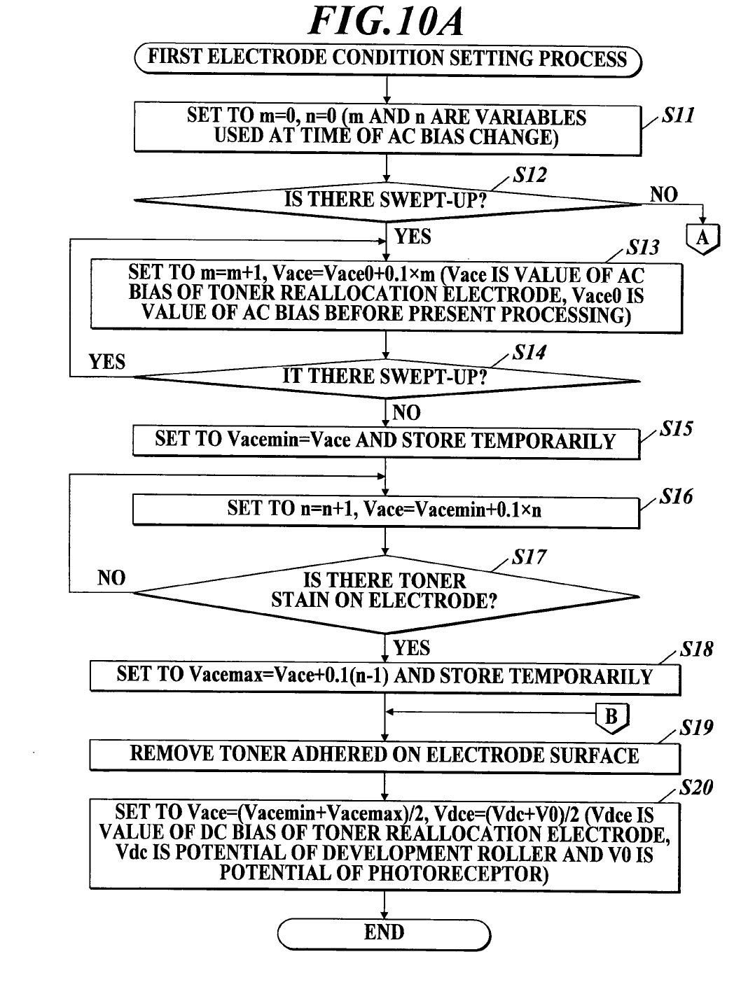

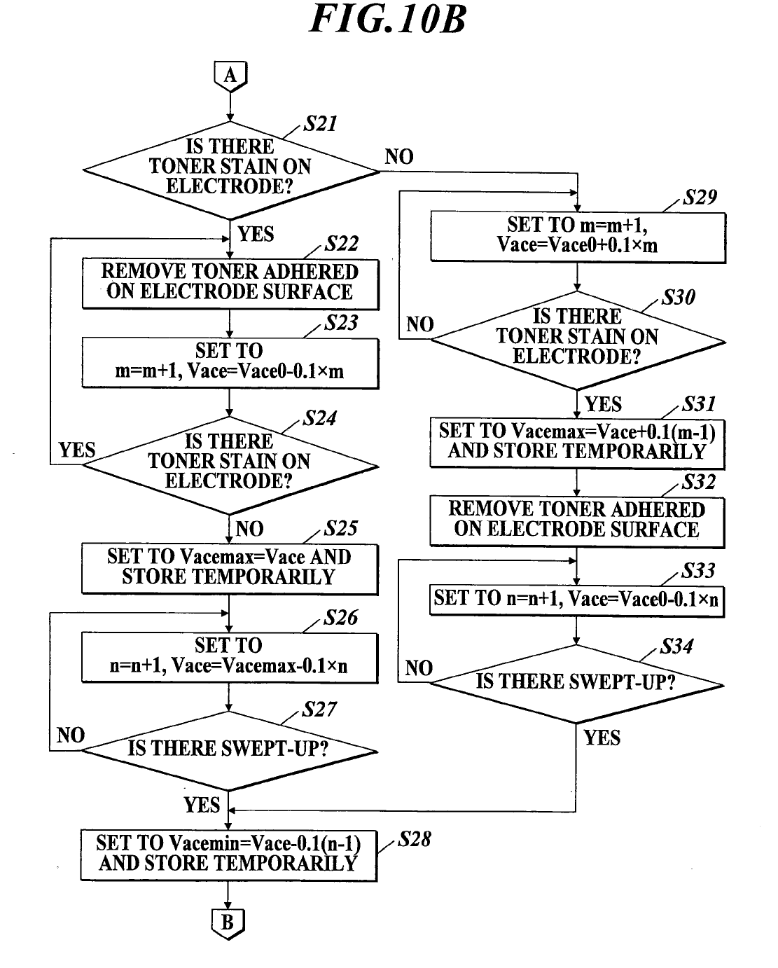

With reference to FIGS. 4 and 5, a detection method of toner stain on the toner reallocation electrode 16Y will be described. The detected toner stain is used as a criterion to determine whether there is toner stain on the toner reallocation electrode 16Y or not in the after-mentioned electrode condition setting process (FIGS. 10A and 10B and FIGS. 12, 14, 16 and 23 to 25).

The toner stain occurs when the bias voltage to be applied to the toner reallocation electrode 16Y is large and when the electric field formed between the toner reallocation electrode 16Y and the photoreceptor 11Y is strong. In order to improve the toner stain, there is a need to make the bias voltage be made small and the electric field be made weak.

In FIG. 4, patch images P1 and P2 are shown. The patch images P1 and P2 are toner images of halftone of 5 mm×5 mm and are formed on the photoreceptor 11Y. Distance between the patch image P1 and the patch image P2 is about 10 mm.

By the IDC sensor 17Y, an irradiation light is irradiated to the patch images P1 and P2 and the reflection light of the irradiation light which is reflected at the patch images P1 and P2 on the photoreceptor 11Y is inputted.

As the density of the toner image formed on the photoreceptor 11Y is greater, the amount of reflection light inputted to the IDC sensor 17Y becomes smaller, and as the density becomes smaller, the amount of reflection light inputted becomes greater.

The toner reallocation electrode 16Y does not carry out the toner reallocation operation to the patch image P1 and carries out the toner reallocation operation to the patch image P2. That is, bias voltage is not applied to the toner reallocation electrode 16Y when the patch image P1 passes by the toner reallocation electrode 16Y and bias voltage is applied to the toner reallocation electrode 16Y when the patch image P2 passes by the toner reallocation electrode 16Y.

The above described operation is carried out with respect to the toner reallocation electrode 16Y, and densities of the patch images P1 and P2 are detected by using the IDC sensor 17Y. In such way, change in toner amounts of the patch image P1 and the patch image P2 can be compared.

When there is change in toner amounts as a result of comparison, it can be said that an amount of toner equivalent to the changed toner amount was adhered to the toner reallocation electrode 16Y.

In FIGS. 5A and 5B, relations between input value of the IDC sensor 17Y and amount of toner adhered on the photoreceptor 11Y are shown.

Graph G1 shows a case where the patch image is Y, M and C, and graph G2 shows a case where the patch image is K. Tendencies shown in the graphs G1 and G2 are similar.

Hereinafter, graph G1 will be described.

The vertical axis indicates input value [V] when the IDC sensor 17Y outputs an irradiation light equivalent to 6V and when the reflection light of the irradiation light which was reflected on the photoreceptor 11Y is inputted.

The horizontal axis indicates amount of toner [g/m²] adhered on the photoreceptor 11Y.

When the irradiation light is irradiated to the patch image P1 and when the input value of the reflection light of the irradiation light which reflected at the patch image P1 is 1.6V, the amount of toner on the photoreceptor 11Y is 1.5 g/m².

When the irradiation light is irradiated to the patch image P2 and when the input value of the reflection light of the irradiation light which reflected at the patch image P2 is 1.8V, the amount of toner on the photoreceptor 11Y is 1.4 g/m².

In the above described case, amount of toner adhered to the toner reallocation electrode 16Y is 1.5 g/m²-1.4 g/m²=0.1 g/m².

In the embodiment, when the condition of the following formula 1 is fulfilled, it is determined that toner stain occurred on the toner reallocation electrode 16Y.

<Formula 1>

(input value of IDC sensor 17Y when bias voltage is ON)−(input value of IDC sensor 17Y when bias voltage is OFF)≧0.25V (1)

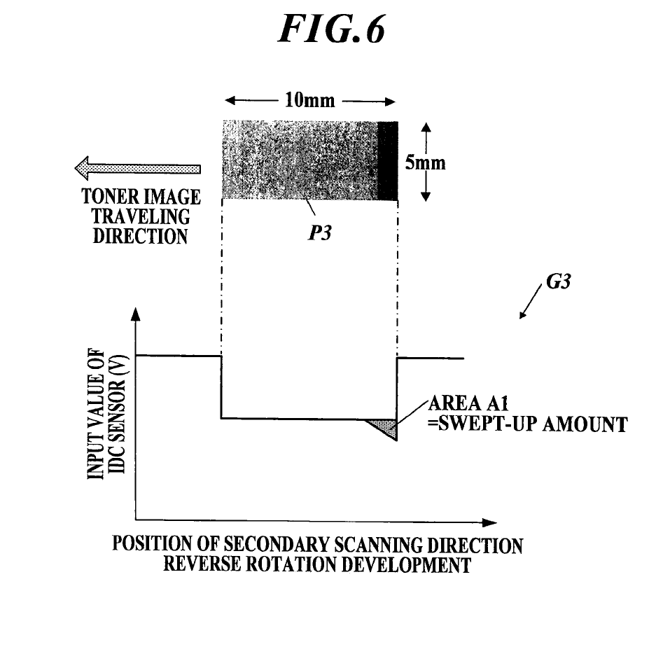

With reference to FIG. 6, a measuring method of swept-up amount will be described.

The amount of density change which is measured (swept-up amount) is used as a criterion to determine whether there is swept-up in a toner image or not in the after mentioned electrode condition setting process (FIGS. 10A and 10B and FIGS. 12, 14, 16 and 23 to 25).

Here, as described above in the description of FIG. 2, the excessive amount of toner at the back end of a toner image when the development method is a reverse rotation development and the excessive amount of toner at the front end of a toner image when the development method is a normal rotation development are called the swept-up.

In order to improve the swept-up, toner reallocation needs to be carried out sufficiently. In order of carry out the toner reallocation sufficiently, there is a need to make the voltage to be applied to the toner reallocation electrode 16Y be large and the electric field formed between the toner reallocation electrode 16Y and the photoreceptor 11Y be strong.

The patch image P3 shown in FIG. 6 is a patch image for detecting swept-up and is formed of a line screen of 5 mm×10 mm, 200 lpi and 45°. Each pixel data is 180/255.

The vertical axis of graph G3 indicates input value [V] when the IDC sensor 17Y outputs an irradiation light and when the reflection light of the irradiation light which is reflected on the photoreceptor 11Y is inputted.

The horizontal axis indicates position in secondary scanning direction.

In graph G3, area of an area A1 is decided as the swept-up amount.

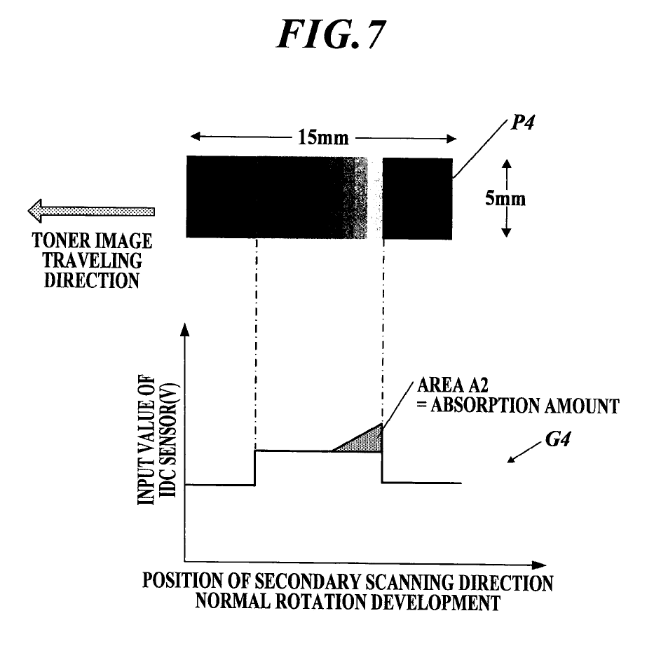

With reference to FIG. 7, a measuring method of an absorption amount will be described.

The amount of density change which is measured (absorption amount) is used as a criterion to determine whether there is an absorption in a toner image or not in the after-mentioned electrode condition setting process (FIGS. 10A and 10B and FIGS. 12, 14 and 16).

Insufficiency in amount of toner in the halftone portion adjacent to a solid part at front in a toner traveling direction when the development method is a reverse rotation development and the halftone portion adjacent to a solid part at back in the toner traveling direction when the development method is a normal rotation development are called the absorptions.

The patch image P4 shown in FIG. 7 is a patch image for detecting absorption and is formed of a line screen of 5 mm×15 mm, 200 lpi and 45°. Each pixel data is 255−180/255−255.

The vertical axis of graph G4 indicates input value [V] when the IDC sensor 17Y outputs an irradiation light and when the reflection light of the irradiation light which is reflected on the photoreceptor 11Y is inputted.

The horizontal axis of graph G4 indicates position in secondary scanning direction.

In graph G4, area of an area A2 is decided as the absorption amount.

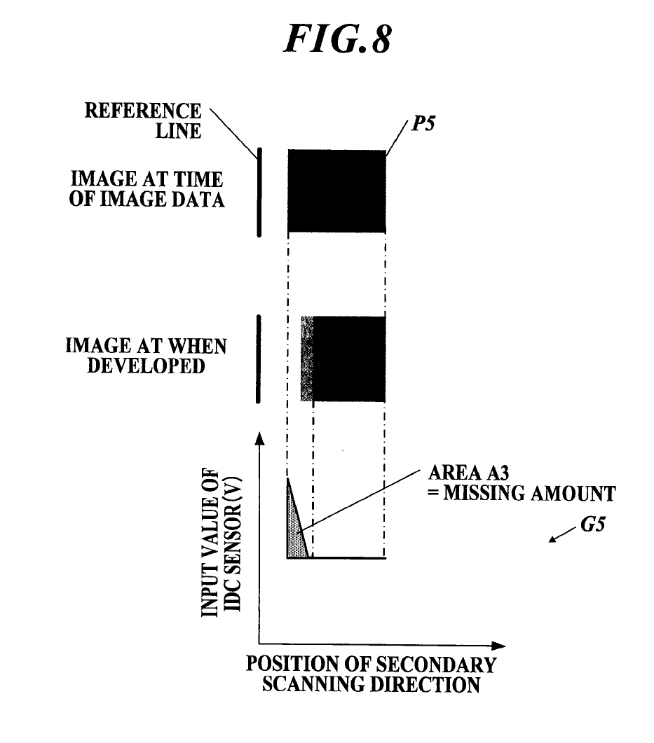

With reference to FIG. 8, a measuring method of missing of density in front end will be described.

The amount of density change which is measured (missing amount) is used as a criterion to determined whether there is missing of density in front end of a toner image or not in the after-mentioned electrode condition setting process (FIGS. 10A and 10B and FIGS. 12, 14 and 16).

As described above in the description of FIG. 2, insufficiency in amount of toner in front end of a toner image when the development method is a reverse rotation development is called the missing of density in front end.

The reference line and the patch image P5 shown in FIG. 8 are a reference line and a patch image for detecting the missing of density in front end, and the patch image P5 is formed of a line screen of 5 mm×10 mm, 200 lip and 45°. Each pixel data is 255−200/255.

The vertical axis of graph G5 indicates input value [V] when the IDC sensor 17Y outputs an irradiation light and when the reflection light of the irradiation light which is reflected on the photoreceptor 11Y is inputted.

The horizontal axis of graph G5 indicates position in secondary scanning direction.

In graph G5, area of an area A3 is decided as the missing amount.

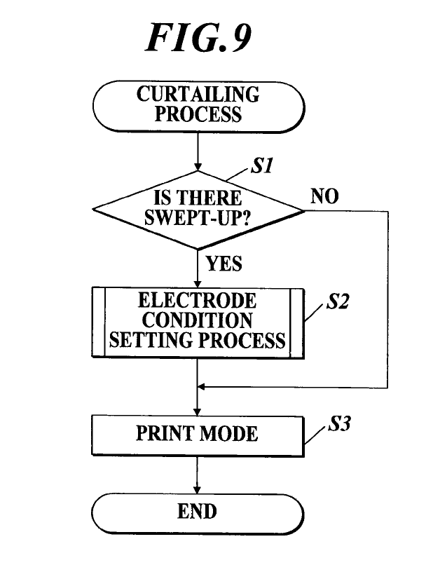

With reference to FIG. 9, a curtailing process will be described.

The control section 42 determines whether swept-up exists in an image formed on a paper or not in a state where voltage is not applied to the toner reallocation electrode 16Y (step S1).

In the determination of whether swept-up exists or not, the control section 42 determines that swept-up exists when the area of area A1 (FIG. 6) is greater than a predetermined value and determines that swept-up does not exist when the area of area A1 is smaller than the predetermined value.

Here, in step S1, existence/non-existence of the swept-up is used as a criterion. However, criterion is not limited to this, and other amount of density change such as existence/non-existence of toner stain (FIGS. 4 and 5), existence/non-existence of absorption (FIG. 7) or existence/non-existence of missing of density in front end (FIG. 8) can be used as a criterion, for example.

When swept-up exists (step S1; Y), the control section 42 moves to an electrode condition setting process (step S2).

The electrode condition setting process will be described later in the description of FIGS. 10A to 17. In the electrode condition setting process, optimization of AC bias value to be applied to the toner reallocation electrode 16Y is mainly carried out.

When swept-up does not exist (step S1; N), the control section 42 curtails the electrode condition setting process (step S2) and moves to a print mode (step S3).

The control section 42 forms an image on a paper in the print mode and finishes the present process.

By carrying out the present process, there is no need to unnecessarily carry out the electrode condition setting process and productivity of the image forming apparatus 10 can be improved.

In the flow of the above FIG. 9, existence/non-existence of swept-up (toner stain, absorption, missing of density) is determined in step S1 and the process moves to the electrode condition setting process when there is swept-up or the like. However, the electrode condition setting process may be carried out at other timing such as the following timings.

Whether to carry out the electrode condition setting process or not can be determined at any one of the following timings; (1) before the image forming apparatus 10 is shipped out from a factory, (2) after replacing the photoreceptor 11Y or a cartridge (omitted from diagram) of the photoreceptor 11Y, (3) after replacing a developer, (4) at the time of environmental change such as when there is humidity change of 15% or greater, (5) when the image forming apparatus 10 is at rest, (6) every predetermined number of papers such as every 50,000 prints or (7) at the time of setting by a user.

Hereinafter, the electrode condition setting process will be described.

With reference to FIGS. 10A and 10B, the first electrode condition setting process will be described.

In the first electrode condition setting process, an intermediate value within a range where swept-up does not occur in a toner image and where toner stain does not occur on the toner reallocation electrode 16Y can be decided as the AC bias value.

The control section 42 sets variables m and n so as to be m=0 and n=0 to initialize (step S11).

The variables m and n are values which are used at the time of AC bias change.

The control section 42 determines whether swept-up exists in the toner image developed on the photoreceptor 11Y or not (step S12).

In the determination of whether swept-up exists or not, the control section 42 determines that swept-up exists when the area of area A1 (FIG. 6) is greater than a predetermined value and the control section 42 determines that swept-up does not exist when the area of area A1 is smaller than the predetermined value.

Here, in step S12, existence/non-existence of swept-up is used as a criterion. However, the criterion is not limited to this, and other amount of density change such as existence/non-existence of absorption (FIG. 7: area A2) or existence/non-existence of missing of density in front end (FIG. 8: area A3), for example, may be used as a criterion.

Replacing of the criterion can be carried out similarly in the present process (FIGS. 10A and 10B) and in other processes (FIGS. 12, 14 and 16).

When swept-up exists (step S12; Y), the control section 42 sets so as to be m=m+1 and Vace=Vace0+0.1×m (step S13).

Vace is a value of AC bias to be applied to the toner reallocation electrode 16Y, and Vace0 is the initial value of AC bias before the present process.

A case where swept-up exists means that the electric field formed between the toner reallocation electrode 16Y and the photoreceptor 11Y is weak and that the effect of toner reallocation is small. Therefore, as described above, the AC bias is increased to make the electric field be stronger.

The control section 42 determines whether swept-up exists or not again after the AC bias is increased (step S14).

When swept-up exists (step S14; Y), there is a need to make the electric field be stronger by increasing the AC bias. Therefore, the control section 42 moves to step S13.

When swept-up does not exist (step S14; N), the control section 42 sets Vacemin so as to be Vacemin=Vace and temporarily stores the value in the storage section 43 (step S15).

Vacemin is the AC bias at the time when the swept-up is gone (hereinafter, called “minimum AC bias”).

The control section 42 sets so as to be n=n+1 and Vace=Vacemin+0.1×n (step S16).

The AC bias is increased even after the swept-up is gone, and this time, AC bias at the time when toner stain occurs on the toner reallocation electrode 16Y is detected.

The control section 42 determines whether toner stain exists on the toner reallocation electrode 16Y or not (step S17).

The criterion for determining whether toner stain exists or not is as shown in the above formula 1.

When swept-up does not exist (step S17; N), the control section 42 repeats steps S16 and S17 in order to increase the AC bias even more until toner stain occurs.

When toner stain exists (step S17; Y), the control section 42 sets so as to be Vacemax=Vace+0.1 (n−1) and temporarily stores the value in the storage section 43 (step S18).

Vacemax is the AC bias (hereinafter, called “maximum AC bias”) just before toner stain occurs in which n is decremented for −1 from the AC bias at the time when toner stain occurred.

The control section 42 removes the toner adhered to the surface of the toner reallocation electrode 16Y by using the cleaning pad 15Y (step S19).

Regarding voltage to be applied to the toner reallocation electrode 16Y, the control section 42 sets AC bias so as to be Vace=(Vacemin+Vacemax)/2 and sets DC bias so as to be Vdce=(Vd+V0)/2 (step S20) and finishes the first electrode condition setting process.

Here, Vdce is a value of DC bias of the toner reallocation electrode 16Y, Vdc is a potential of the development roller 141Y and V0 is a potential of the photoreceptor 11Y.

The control range from the value of minimum AC bias to the value of maximum AC bias is a range where there is no swept-up or toner stain. That is, this is a range where deterioration of image quality does not occur. Hereinafter, this range is called “proper range” and description will be given.

In step S20, the control section 42 decides an intermediate value of the proper range as the AC bias and decides an intermediate value of the potential of the development roller 141Y and the potential of the photoreceptor 11Y as the DC bias.

Returning to step S12, when swept-up does not exit (step S12; N), the control section 42 determines whether toner stain exists on the toner reallocation electrode 16Y or not (step S21).

When toner stain exists (step S21; Y), the control section 42 removes the toner adhered to the toner reallocation electrode 16Y by using the cleaning pad 15Y (step S22).

The control section 42 sets so as to be m=m+1 and Vace=Vace0−0.1×m (step S23).

When toner stain exists, the electric field formed between the toner reallocation electrode 16Y and the photoreceptor 11Y is strong and toner is being pulled toward the electrode. Therefore, the AC bias is decreased to make the electric field be weaker as described above.

The control section 42 determines whether toner stain exists or not again after the AC bias is decreased (step S24).

When there is toner stain (step S24; Y), there is a need to make the electric field be weaker by decreasing the AC bias even more. Therefore, the control section 42 repeats steps S22 to S24.

when toner stain does not exist (step S24; N), the control section 42 sets Vacemax so as to be Vacemax=Vace and temporarily stores the value in the storage section 43 (step S25).

The control section 42 sets so as to be n=n+1 and Vace=Vacemax−0.1×n (step S26).

This time, the AC bias is decreased as described above and the control section 42 detects the minimum AC bias (Vacemin).

The control section 42 determines whether swept-up exists or not (step S27).

When swept-up does not exist (step S27; N), the control section moves to step S26.

When swept-up exists (step S27; Y), the control section 42 sets so as to be Vacemin=Vace−0.1 (n−1) and temporarily stores the value in the storage section 43 (step S28).

The control section 42 carries out the above described steps S19 and S20, and decides an appropriate AC bias value to be applied to the toner reallocation electrode 16Y to finish the first electrode condition setting process.

Returning to step S21, when toner stain does not exist (step S21; N), the control section 42 moves to step S29.

Here, the case where the control section 42 moves to step S29 is a case where swept-up does not exist (step S12; N) and where toner stain does not exist (step S21; N) and it can be said that the initial AC bias value (Vace0) before the present process is within the proper range.

However, although it is within the proper range, there is a possibility that the AC bias is a value close to the maximum Ac bias or the minimum AC bias. In such case, there is a possibility that the AC bias value falls out from the proper range depending on the setting environment and the frequency of usage of the image forming apparatus. In order to decide a value which does not easily fall out from the proper range, that is, an intermediate value of the proper range, the control section 42 detects the maximum AC bias and the minimum AC bias in the process after step S29.

The control section 42 sets so as to be m=m+1 and Vace=Vace0+0.1×m (step S29), and determines whether toner stain exists on the toner reallocation electrode 16Y or not (step S30).

When toner stain does not exist (step S30; N), the control section 42 moves to step S29 to increase the AC bias even more to the point where toner stain occurs.

When toner stain exists (step S30; Y), the control section 42 sets so as to be Vacemax=Vace+0.1 (m⁻¹) and temporarily stores the value in the storage section 43 (step S31).

The control section 42 removes the toner adhered to the surface of the toner reallocation electrode 16Y by using the cleaning pad 15Y (step S32).

The control section 42 sets so as to be n=n+1 and Vace=Vace0−0.1×n (step S33) and determines whether swept-up exists or not (step S34).

When swept-up does not exist (step S34; N), the control section 42 moves to step S33 to decrease the AC bias to the point where swept-up occurs.

When swept-up exists (step S34; Y), the control section 42 sets so as to be Vacemin=Vace−0.1 (n−1) and temporarily stores the value in the storage section 43 (step S28).

The control section 42 carries out the above described steps S19 and S20 and decides an appropriate AC bias to be applied to the toner reallocation electrode 16Y to finish the first electrode condition setting process.

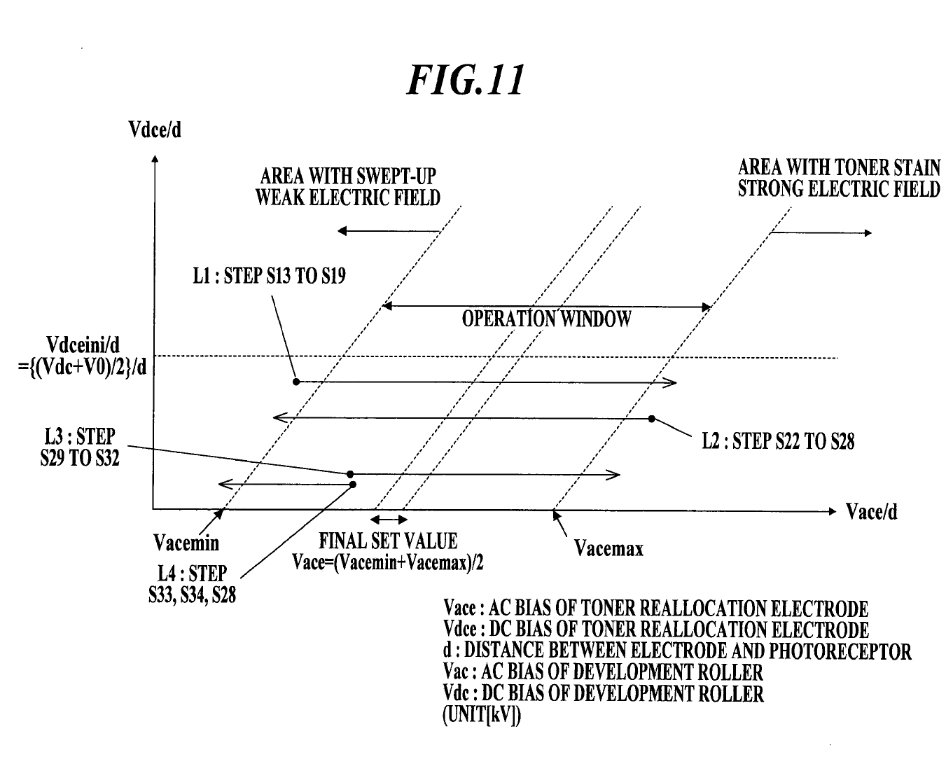

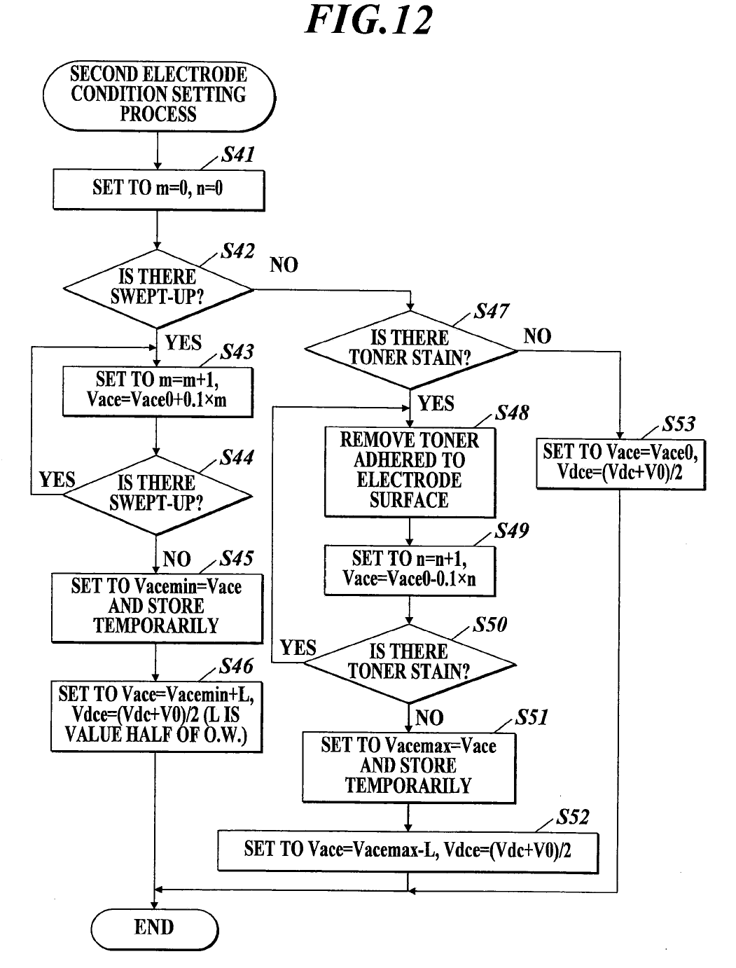

In FIG. 11, a schematic diagram of the first electrode condition setting process is shown.

The vertical axis indicates Vdce/d and the horizontal axis indicates Vace/d.

Vdce is DC bias value of the toner reallocation electrode 16Y, d is a distance between the toner reallocation electrode 16Y and the photoreceptor 11Y and Vace is AC bias value of the toner reallocation electrode 16Y.

O.W. (operation window) is a range where swept-up or toner stain does not exist. That is a range where deterioration of image quality does not occur and applies to the proper range described in the process description of FIGS. 10A and 10B.

Vacemin is the value of minimum AC bias and is the AC bias value just before swept-up occurs. The minimum AC bias is set based on whether the amount of density change (swept-up amount=area A1 or the like) is greater than a predetermined value or not (see step S14).

Vacemax is the value of maximum AC bias and is the AC bias value just before toner stain occurs. The maximum AC bias is set based on whether the toner stain is greater than a predetermined value (0.25V; see formula 1) or not (see step S17).

The final set value is a value where Vacemin and Vacemax are added and the sum thereof is divided by 2, that is, an intermediate value of the proper range, and is the AC bias value which is finally decided in the process of FIGS. 10A and 10B.

L1 indicates a transition of AC bias when the processes of steps S13 to S19 (FIG. 10A) are carried out.

L2 indicates a transition of AC bias when the processes of steps S22 to S28 (FIG. 10B) are carried out.

L3 indicates a transition of AC bias when the processes of steps S29 to S32 (FIG. 10B) are carried out.

L4 indicates a transition of AC bias when the processes of steps S33, S34 and S28 (FIG. 10B) are carried out.

As shown in FIG. 11, by the first electrode condition setting process (FIGS. 10A and 10B), the AC bias to be applied to the toner reallocation electrode 16Y is decided so as to be close to the intermediate value of the proper range (O.W.) and the AC bias value does not easily fall out from the proper range (O.W.). By carrying out the first electrode condition setting process once, the interval for resetting the electrode condition can be made longer.

With reference to FIG. 12, the second electrode condition setting process will be described.

In the second electrode condition setting process, the process time can be shortened compared to the first electrode condition setting process (see FIGS. 10A and 10B). The second electrode condition setting process is an effective process in a case where the proper range (O.W.) is predetermined to some extent. Here, description will be given by assuming that the proper range is predetermined so as to be proper range=2 L.

The control section 42 sets variables m and n so as to be m=0 and n=0 to initialize (step S41).

The control section 42 determines whether swept-up exists or not (step S42).

When swept-up exists (step S42; Y), the control section 42 sets so as to be m=m+1 and Vace=Vace0+0.1×m to detect the minimum AC bias (step S43).

The control section 42 increases the AC bias and determines whether swept-up exists or not again (step S44).

When swept-up does not exist (step S44; Y), the control section 42 repeats steps S43 and S44.

When swept-up does not exist (step S44; N), the control section 42 sets so as to be Vacemin=Vace and temporarily stores the value in the storage section 43 (step S45).

The control section 42 sets so as to be Vace=Vacemin+L and Vdce=(Vdc+V0)/2 (step S46) and finishes the second electrode condition setting process.

L is a value at half of the proper range (O.W.).

The second electrode condition setting process is a process for a case where the proper range is predetermined so as to be proper range=2 L. Therefore, by adding the value L which is a value at half of the proper range to the minimum AC bias, the AC bias can be decided easily so as to be close to the intermediate value of the proper range.

Returning to step S42, when swept-up does not exist (step S42; N), the control section 42 determines whether toner stain exists or not (step S47).

When toner stain exists (step S47; Y), the control section 42 removes the toner adhered to the electrode surface by using the cleaning pad 15Y (step S48) and sets so as to be n=n+1 and Vace=Vace0−0.1×n (step S49) in order to detect the maximum AC bias.

The control section 42 determines whether toner stain exists or not again (step S50).

When toner stain exists (step S50; Y), the control section 42 repeats steps S48 to S50 until the maximum AC bias is detected.

When toner stain does not exist (step S50; N), the control section 42 sets so as to be Vacemax=Vace and temporarily stores the value in the storage section 43 (step S51).

The control section 42 sets so as to be Vace=Vacemax−L and Vdce=(Vdc+V0)/2 (step S46) and finishes the second electrode condition setting process.

By subtracting the value L which is a value at half of the proper range from the maximum AC bias, the AC bias can be easily decided so as to be a value close to the intermediate value of the proper range.

Returning to step S47, when toner stain does not exist (step S47; N), the control section 42 sets so as to be Vace=Vace0 and Vdce=(Vdc+V0)/2 (step S53) and finishes the second electrode condition setting process.

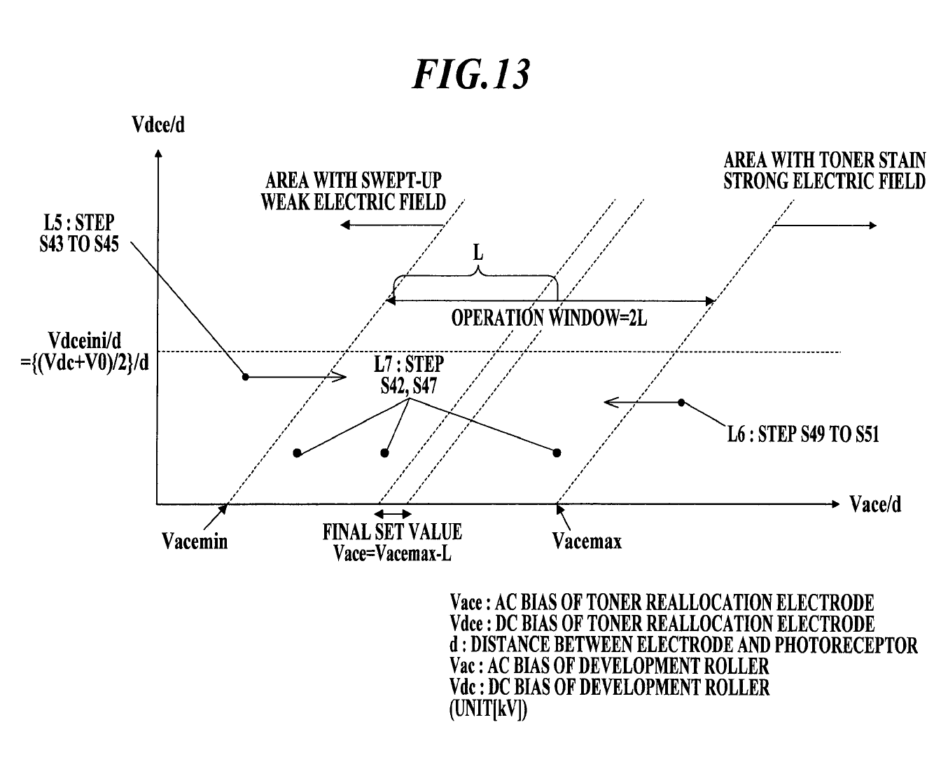

In FIG. 13, a schematic diagram of the second electrode condition setting process is shown.

The vertical axis indicates Vdce/d and the horizontal axis indicates Vace/d.

Vdce is DC bias value of the toner reallocation electrode 16Y, d is a distance between the toner reallocation electrode 16Y and the photoreceptor 11Y and Vace is AC bias value of the toner reallocation electrode 16Y.

Regarding proper range (O.W.), Vacemin, Vacemax and final set value (Vace), they are similar to the content of the description given for FIG. 11, therefore, the description is omitted here.

L5 indicates a transition of the AC bias when the processes of steps S43 to S45 (FIG. 12) are carried out.

L6 indicates a transition of the AC bias when the processes of steps S49 to S51 (FIG. 12) are carried out.

L7 indicates a position when there is no swept-up or toner stain in the processes of steps S42 and S47 (FIG. 12).

As shown in FIG. 13, when the proper range (O.W.) is predetermined so as to be proper range=2 L, the AC bias to be applied to the toner reallocation electrode 16Y is easily decided so as to be close to the intermediate value of the proper range (O.W.) by the second electrode condition setting process (FIG. 12). In the second electrode condition setting process (FIG. 12), an effect similar to the first electrode condition setting process (FIGS. 10A and 10B) is obtained, and also, the process time can be shortened comparing to the first electrode condition setting process.

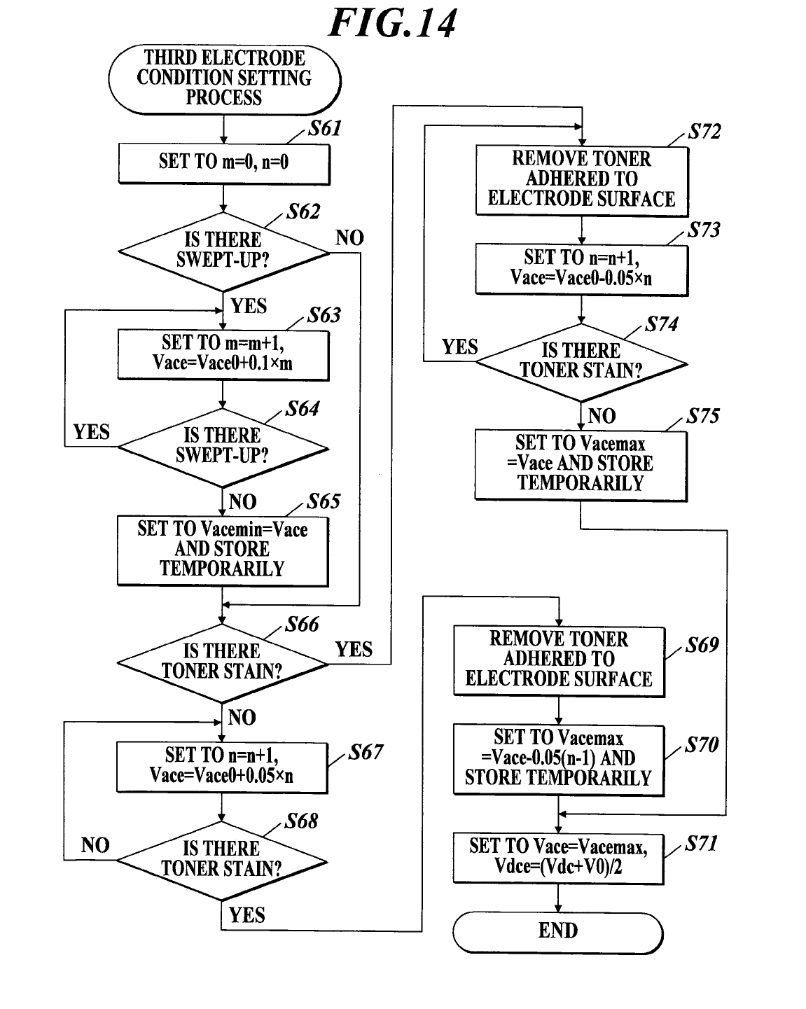

With reference to FIG. 14, the third electrode condition setting process will be described.

In the third electrode condition setting process, a value greater than the AC bias value decided in the first and the second electrode condition setting processes (FIGS. 10A, 10B and FIG. 12) is decided as the AC bias value. By the third electrode condition setting process, the effect of toner reallocation can be improved.

The third electrode condition setting process is a process which is effective under the environment where swept-up easily occurs.

The control section 42 sets variables m and n so as to be m=0 and n=0 to initialize (step S61).

The control section 42 determines whether swept-up exists or not (step S62).

When swept-up exists (step S62; Y), the control section 42 sets so as to be m=m+1 and Vace=Vace0+0.1×m (step S63).

The control section 42 increases the AC bias, and thereafter determines whether swept-up exists or not again (step S64).

When swept-up exists (step S64; Y), the control section 42 moves to step S63.

When swept-up does not exist (step S64; N), the control section 42 sets the minimum AC bias so as to be Vacemin=Vace and temporarily stores the value in the storage section 43 (step S65).

The control section 42 determines whether toner stain exists or not (step S66).

When toner stain does not exist (step S66; N), the control section 42 sets so as to be n=n+1 and Vace=Vace0+0.05×n (step S67).

The control section 42 increases the AC bias, and thereafter determines whether toner stain exists or not again (step S68).

When toner stain does not exist (step S68; N), the control section 42 repeats steps S67 and S68.

When toner stain exists (step S68; Y), the control section 42 removes the toner adhered to the surface of the toner reallocation electrode 16Y by using the cleaning pad 15Y (step S69).

The control section 42 sets so as to be Vacemax=Vace−0.05 (n−1) and temporarily stores the value in the storage section 43 (step S70).

The control section 42 sets so as to be Vace=Vacemax and Vdce=(Vdc+V0)/2 (step S71) and finishes the third electrode condition setting process.

Returning to step S62, when swept-up does not exist (step S62; N), the control section 42 moves to step S66.

After moving to step S66, when toner stain does not exist (step S66; N), the control section 42 finishes the third electrode condition setting process via steps S67 to S71.

Returning to step S66, when toner stain exists (step S66; Y), the control section 42 removes the toner adhered to the surface of the toner reallocation electrode 16Y by using the cleaning pad 15Y (step S72).

The control section 42 sets so as to be n=n+1 and Vace=Vace0−0.05×n (step S73).

The control section 42 determines whether there is toner stain or not (step S74).

When toner stain exists (step S74; Y), the control section 42 repeats steps S72 to S74.

When toner stain does not exist (step S74; N), the control section 42 sets so as to be Vacemax=Vace and temporarily stores the value in the storage section 43 (step S75).

The control section 42 finishes the third electrode condition setting process via step S71.

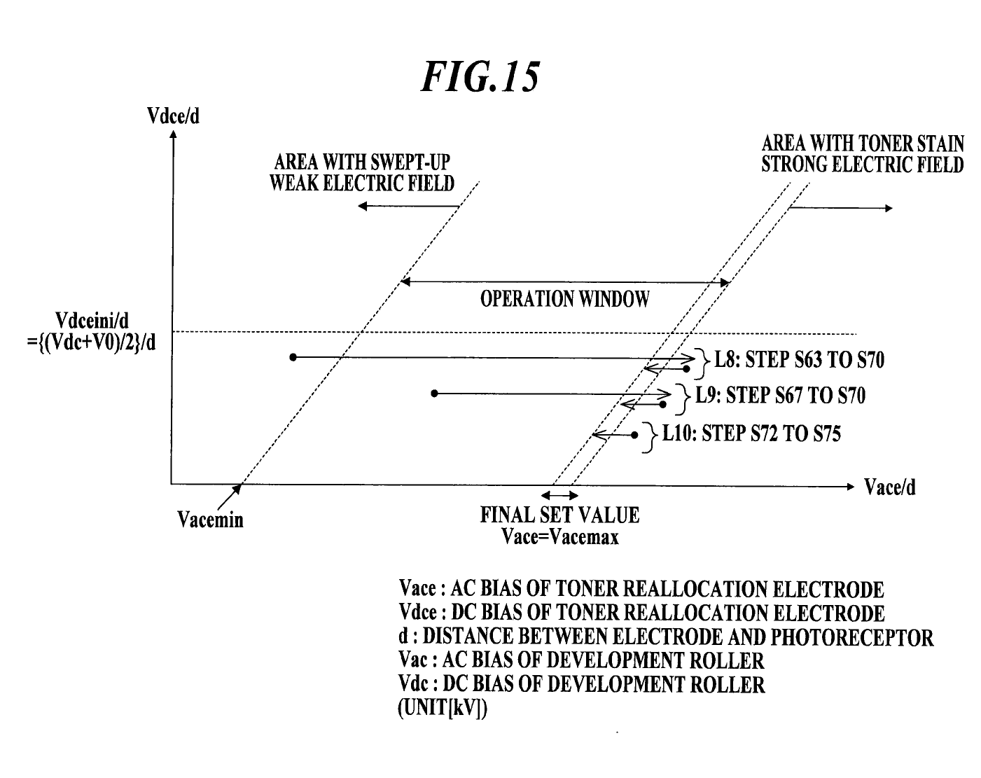

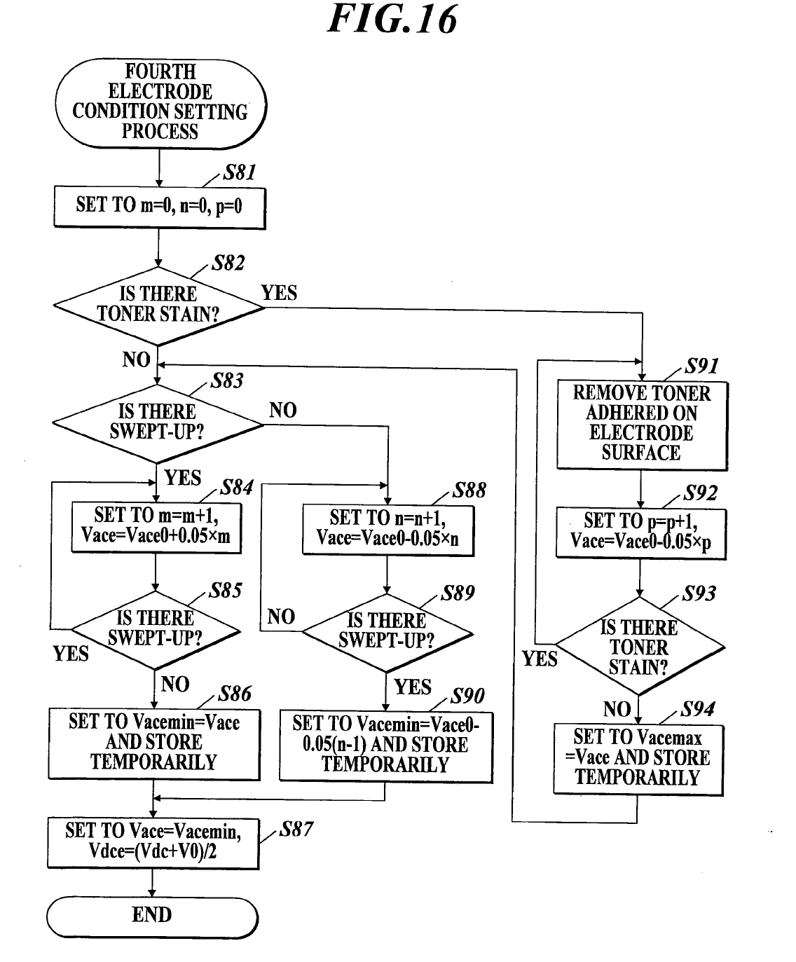

In FIG. 15, a schematic diagram of the third electrode condition setting process is shown.

The vertical axis indicates Vdce/d and the horizontal axis indicates Vace/d.

Vdce is DC bias value of the toner reallocation electrode 16Y, d is a distance between the toner reallocation electrode 16Y and the photoreceptor 11Y and Vace is AC bias value of the toner reallocation electrode 16Y.

Regarding proper range (O.W.), Vacemin, Vacemax and final set value (Vace), they are similar to the content of the description of FIG. 11, therefore, the description is omitted here.

L8 indicates a transition of the AC bias when the processes of steps S63 to S70 (FIG. 14) are carried out.

L9 indicates a transition of the AC bias when the processes of steps S67 to S70 (FIG. 14) are carried out.

L10 indicates a transition of the AC bias when the processes of steps S72 to S75 (FIG. 14) are carried out.

As shown in FIG. 15, the AC bias to be applied to the toner reallocation electrode 16Y is decided to the maximum value within the proper range (O.W.) by the third electrode condition setting process (FIG. 14). Therefore, toner stain can be prevented from occurring and also a great effect of image quality improvement (effect of toner reallocation) can be obtained.

With reference to FIG. 16, the fourth electrode condition setting process will be described.

In the fourth electrode condition setting process, a value smaller than the AC bias value decided in the first and the second electrode condition setting processes (FIGS. 10A and 10B and FIG. 12) is decided as the AC bias value. The fourth electrode condition setting process is a process which is effective under the environment where toner is easily adhered to the toner reallocation electrode 16Y.

The control section 42 sets variables m, n and p so as to be m=0, n=0 and p=0 to initialize (step S81).

The control section 42 determines whether toner stain exists or not (step S82).

When toner stain does not exist (step S82; N), the control section 42 determines whether swept-up exists or not (step S83).

When swept-up exists (step S83; Y), the control section 42 sets so as to be m=m+1 and Vace=Vace0+0.05×m (step S84).

The control section 42 increases the AC bias, and thereafter determines whether swept-up exists or not again (step S85).

When swept-up exists (step S85; Y), the control section 42 repeats steps S84 and S85.

When swept-up does not exist (step S85; N), the control section 42 sets so as to be Vacemin=Vace and temporarily stores the value in the storage section 43 (step S86).

The control section 42 sets so as to be Vace=Vacemin and Vdce=(Vdc+V0)/2 (step S87) and finishes the fourth electrode condition setting process.

Returning to step S83, when swept-up does not exist (step S83; N), the control section 42 sets so as to be n=n+1 and Vace=Vace0−0.05×n (step S88).

The control section 42 decreases the AC bias, and thereafter determines whether swept-up exists or not again (step S89).

When swept-up does not exist (step S89; N), the control section 42 repeats steps S88 and S89.

When swept-up exists (step S89; N), the control section 42 sets so as to be Vacemin=Vace0−0.05 (n−1) and temporarily stores the value in the storage section 43 (step S90).

The control section 42 finishes the fourth electrode condition setting process via step S87.

Returning to step S82, when toner stain exists (step S82; Y), the control section 42 removes the toner adhered on the surface of the toner reallocation electrode 16Y by using the cleaning pad 15Y (step S91).

The control section 42 sets so as to be p=p+1 and Vace=Vace0−0.05×p (step S92).

The control section 42 decreases the AC bias, and determines whether toner stain exists or not again (step S93).

When toner stain exists (step S93; Y), the control section 42 repeats steps S91 to S93.

When toner stain does not exist (step S93; N), the control section 42 sets so as to be Vacemax=Vace and temporarily stores the value in the storage section 43 (step S94).

After moving to step S83, the control section 42 finishes the fourth electrode condition setting process via steps S83, S88 to S90 and S87.

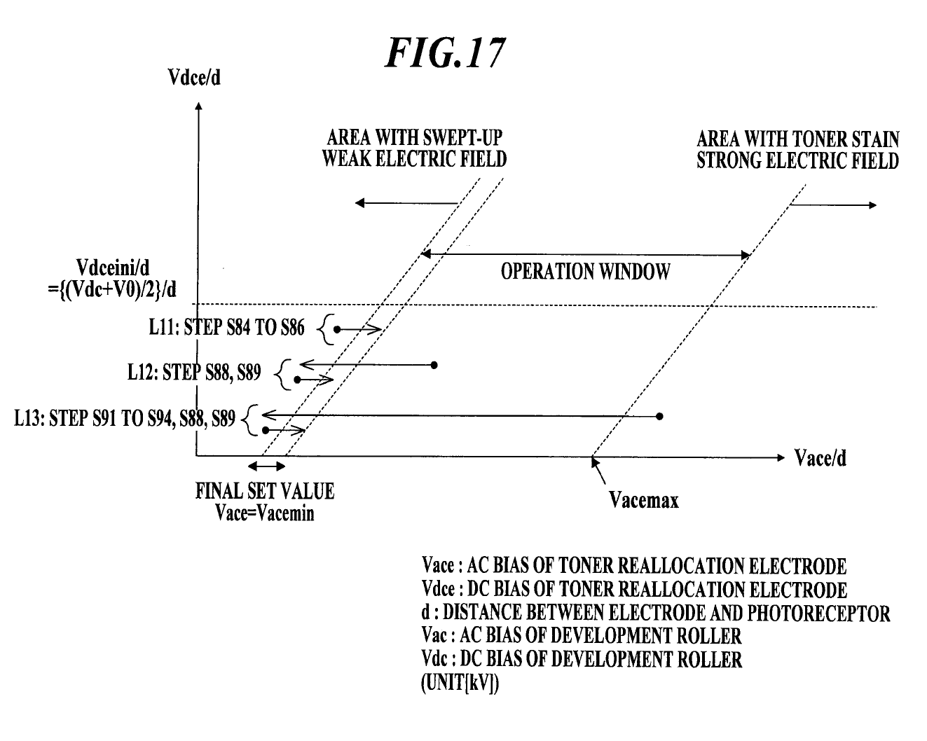

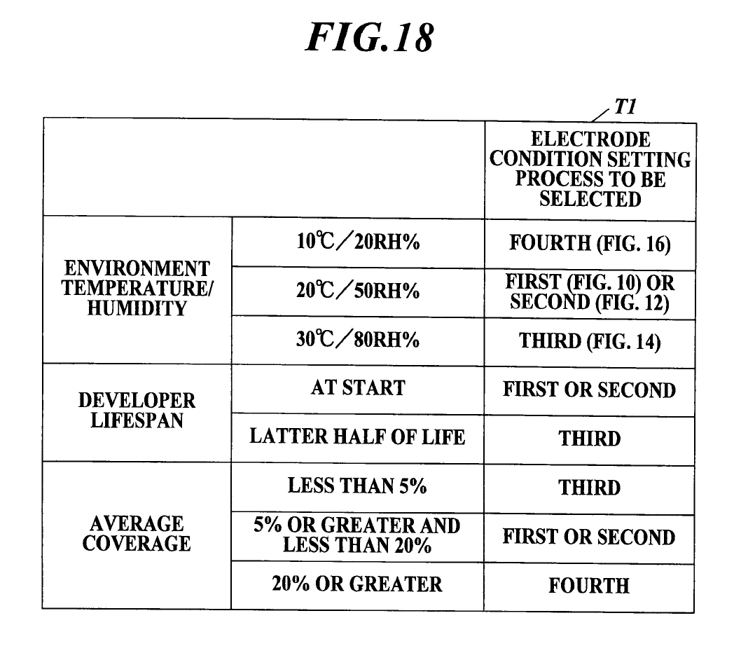

In FIG. 17, a schematic diagram of the fourth electrode condition setting process is shown.

The vertical axis indicates Vdce/d and the horizontal axis indicates Vace/d.

Vdce is DC bias value of the toner reallocation electrode 16Y, d is a distance between the toner reallocation electrode 16Y and the photoreceptor 11Y and Vace is AC bias value of the toner reallocation electrode 16Y.

Regarding proper range (O.W.), Vacemin, Vacemax and final set value (Vace), they are similar to the content of the description of FIG. 11, therefore, the description is omitted here.

L11 indicates a transition of the AC bias when the processes of steps S84 to S86 (FIG. 16) are carried out.

L12 indicates a transition of the AC bias when the processes of steps S88 and S89 (FIG. 16) are carried out.

L13 indicates a transition of the AC bias when the processes of steps S91 to S94, S88 and S89 (FIG. 16) are carried out.

As shown in FIG. 17, the AC bias value to be applied to the toner reallocation electrode 16Y is decided to the minimum value within the proper range (O.W.) by the fourth electrode condition setting process (FIG. 16). In the fourth electrode condition setting process, toner stain can be prevented from occurring under the environment where toner easily adheres to the toner reallocation electrode 16Y and also swept-up can be prevented from occurring.

In FIG. 18, an example of the criteria table is shown.

The criteria table T1 is a table set for determining which of the above described the first to the fourth electrode condition setting processes (see FIGS. 10A and 10B and FIGS. 12, 14 and 16) is to be used to determine the AC bias value.

In the criteria table T1, (1) environment, (2) developer lifespan and (3) average coverage are made to correspond with either one of the first to the fourth electrode condition setting processes.

The criteria table T1 is stored in the storage section 43.

The control section 42 selects either one of the above described first to fourth electrode condition setting process based on various types of data outputted from the temperature/humidity detection section 44, the counting section 45 and the average coverage calculation section 46 and the criteria table T1.

In a case where the environment has temperature of 10° C. and humidity of 20% (low-temperature and humidity), charged amount of toner is large and the toner can easily follow the electric field. That is, the toner easily adheres to the toner reallocation electrode 16Y. Therefore, the environmental condition of low-temperature and humidity is corresponded with the fourth electrode condition setting process (FIG. 16).

In a case where the environment has temperature of 20° C. and humidity of 50% (normal-temperature and humidity), charged amount of toner is stable. Therefore, the environmental condition of normal-temperature and humidity is corresponded with the first electrode condition setting process (FIGS. 10A and 103) or the second electrode condition setting process (FIG. 12).

In a case where the environment has temperature of 30° C. and humidity of 80% (high-temperature and humidity), charged amount of toner is small and swept-up occurs easily. Therefore, the environmental condition of high-temperature and humidity is corresponded with the third electrode condition setting process (FIG. 14).

In a case where the developer lifespan is at the time of introduction of the developer (at start), charged amount of toner is stable. Therefore, at start of the developer lifespan is corresponded with the first electrode condition setting process or the second electrode condition setting process.

In a case where the developer lifespan is almost over (latter half of life), charged amount of toner is small and swept-up occurs easily. Therefore, latter half of developer lifespan is corresponded with the third electrode condition setting process.

In a case where the average coverage is smaller than 5%, toner does not easily move due to submerging of external additive or the like. Therefore, the case where the average coverage is smaller than 5% is corresponded with the third electrode condition setting process.

In a case where the average coverage is 5% or greater and smaller than 20%, charged amount of toner is stable. Therefore, the case where the average coverage is 5% or greater and smaller than 20% is corresponded with the first electrode condition setting process.

In a case where the average coverage is 20% or greater, percentage of new toner is great and toner can move easily. Therefore, the case where the average coverage is 20% or greater is corresponded with the fourth electrode condition setting process.

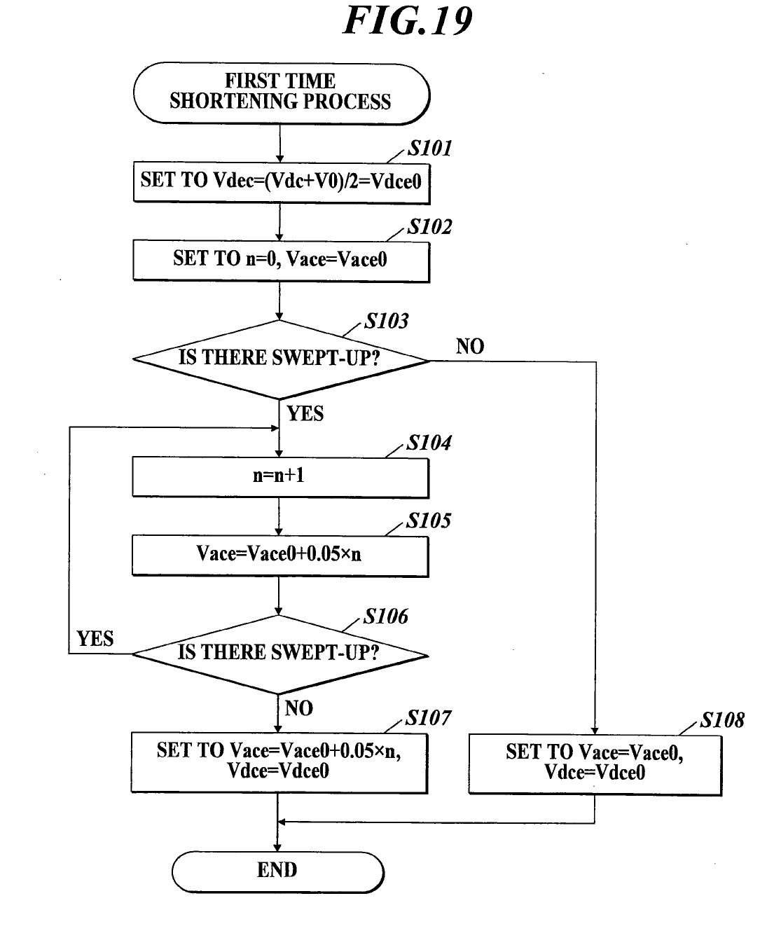

With reference to FIG. 19, the first time shortening process will be described.

In the first time shortening process, time needed until deciding the AC bias value over again to the value within the proper range can be shortened in such case where swept-up occurs due to the AC bias value falling out from the proper range (O.W.).

The control section 42 sets so as to be Vdce=(Vdc+V0)/2=Vdce0 to initialize (step S101).

The control section 42 sets so as to be n=0 and Vace=Vace0 to initialize (step S102).

The control section 42 determines whether swept-up exists or not (step S103).

When swept-up exists (step S103; Y), the control section 42 sets so as to be n=n+1 (step S104).

The control section sets so as to be Vace−Vace0+0.05×n (step S105).

The control section 42 increases the AC bias, and thereafter determines whether swept-up exists or not again (step S106).

When swept-up exists (step S106; Y), the control section 42 repeats steps S104 to S106.

When swept-up does not exist (step S106; N), the control section 42 sets so as to be Vace=Vace0+0.05×n and Vdce=Vdce0 (step S107) and finishes the first time shortening process.

Returning to step S103, when swept-up does not exist (step S103; N), the control section 42 sets so as to be Vace=Vace0 and Vdce=Vdc0 (step S108) and finishes the first time shortening process.

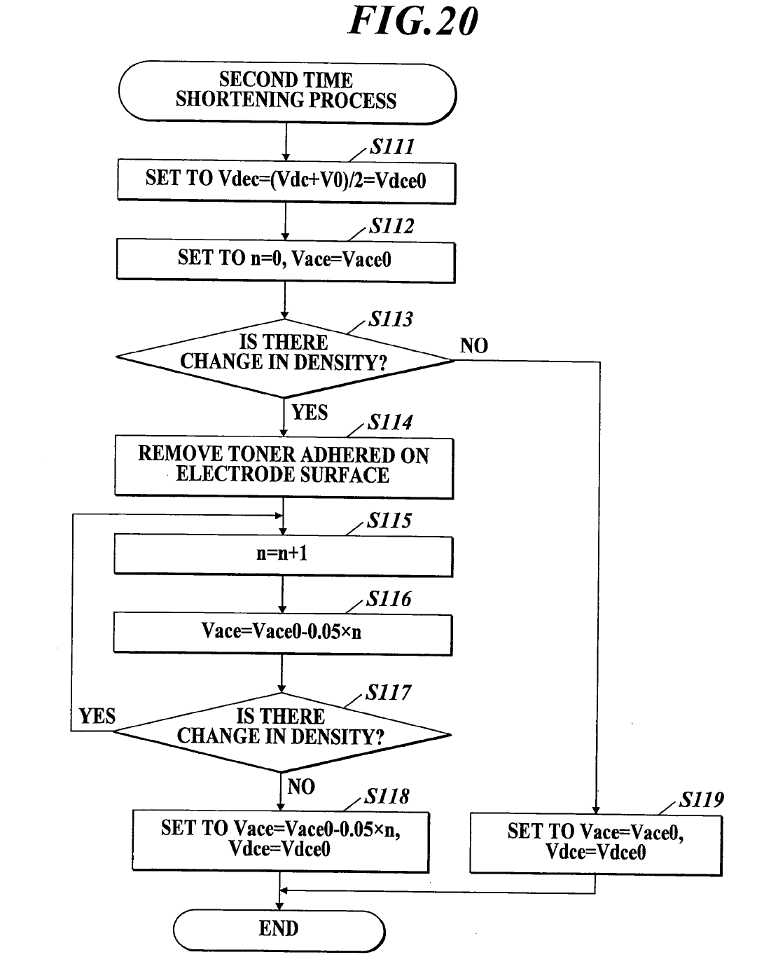

With reference to FIG. 20, the second time shortening process will be described.

In the second time shortening process, time needed until deciding the AC bias value over again to a value within the proper range can be shortened in such case where toner stain occurs due to the AC bias value falling out from the proper range (O.W.).

Steps S111 and S112 are similar to steps S101 and S102 of FIG. 19.

The control section 42 determines whether there is density change or not (step S113).

In the determination of whether there is density change or not, the control section 42 carries out the determination based on the absorption amount (FIG. 7; area A2) or the missing amount (FIG. 8; area A3).

When there is density change (step S113; Y), the control section 42 removes the toner adhered to the surface of the toner reallocation electrode 16Y (step S114).

The control section 42 sets so as to be n=n+1 (step S115).

The control section 42 sets so as to be Vace=Vace0−0.05×n (step S116).

The control section 42 decreases the AC bias, and thereafter determines whether there is density change or not again (step S117).

When there is density change (step S117; Y), the control section 42 repeats steps S115 to S117.

When there is no density change (step S117; N), the control section 42 sets so as to be Vace=Vace0−0.05×n and Vdce=Vdce0 (step S118) and finishes the second time shortening process.

Returning to step S113, when there is no density change (step S113; N), the control section 42 sets so as to be Vace=Vace0 and Vdce=Vdce0 (step S119) and finishes the second time shortening process.

With reference to tables 2 to 4, performance confirmation test will be described.

Common conditions for the embodiment example and the comparison example in the performance confirmation test are as shown in the following table 2.

TABLE 2

| | |
|---|---|
| Environment: | normal-temperature and humidity |
| | (temperature: 20° C., |
| | humidity: 50%) |
| Diameter of photoreceptor: | 60 mm |
| Diameter of development roller: | 25 mm |
| Surface speed of development roller: | 720 mm |
| | (reverse rotation development) |
| Distance between development | 0.3 mm |
| roller and photoreceptor: | |
| Transport amount of developer on | 220 g/m² |
| development roller: | |
| Image forming apparatus: | black and white 80 ppm |
| Process speed: | 400 mm/s |
| Diameter of toner: | 6.5 μm |
| Diameter of carrier: | 33 μm |
| Density of toner: | 7 wt % |
| Amount of developer in | 1000 g |
| development device: | |
| Condition of toner reallocation | DC bias = −600 V |
| electrode at time of test start: | AC bias = 2.5 kV, f = 9 kHz, |
| | gap = 0.3 mm |
| Patch image: | patch image P3(FIG. 6) for |
| | swept-up detection is used |
| | Line screen of 200 lpi at 600 dpi |
| | Density data = 180/255 |

### Embodiment

### Embodiment Example 1

In the embodiment example 1, the first electrode condition setting process (FIGS. 10A and 10B) is carried out for each of the cases where the distance between the toner reallocation electrode 16Y and the photoreceptor 11Y is 0.24 mm, 0.3 mm and 0.36 mm. Thereafter, bias voltage is applied to the toner reallocation electrode 16Y to carryout printing operation.

### Comparison Example 1

In the comparison example 1, the first electrode condition setting process (FIGS. 10A and 10B) is not carried out for each of the above described cases where the distance between the toner reallocation electrode 16Y and the photoreceptor 11Y is 0.24 mm, 0.3 mm and 0.36 mm, and bias voltage is applied to the toner reallocation electrode 16Y to carryout printing operation.

Results of the performance confirmation test 1 are as shown in the following table 3.

TABLE 3

| Distance | | | | |
|---|---|---|---|---|
| between toner | | | | |
| reallocation | Swept-up | | Noise | |
| electrode | Embodiment | | Embodiment | |
| and photoreceptor | Ex. | Comp. Ex. | Ex. | Comp. Ex. |
| 0.24 mm | ◯ | ◯ | ◯ | X |
| 0.3 mm | ◯ | ◯ | ◯ | ◯ |
| 0.36 mm | ◯ | X | ◯ | ◯ |

As for evaluation (◯ evaluation/X evaluation), ◯ evaluation is given when swept-up and noise are not visually recognized at all and X evaluation is given when swept-up and noise are visually recognized overall or partially.

As shown in table 3, when the distance between the toner reallocation electrode 16Y and the photoreceptor 11Y is 0.24 mm, swept-up was not recognized in both the embodiment example 1 and the comparison example 1 (◯ evaluation).

Noise was not recognized in the embodiment example 1 (◯ evaluation), however, was recognized in the comparison example 1 (X evaluation).

When the distance is 0.3 mm, swept-up and noise were not recognized in both the embodiment example 1 and the comparison example 1 (◯ evaluation).

When the distance is 0.36 mm, swept-up was not recognized in the embodiment example 1 (◯ evaluation), however, was recognized in the comparison example 1 (X evaluation).

Noise was not recognized in both the embodiment example 1 and the comparison example 1 (◯ evaluation).

Here, in the first embodiment, results similar to the above table 3 was also obtained when the second to the fourth electrode condition setting processes (FIGS. 12, 14 and 16) were carried out.

### Embodiment Example 2

In the embodiment example 2, after the first electrode condition setting process (FIGS. 10A and 10B) is carried out, printing operation of 10,000 papers was carried out by applying bias voltage to the toner reallocation electrode 16Y under the environment of normal-temperature and humidity and high-temperature and humidity.

Under the environment of high-temperature and humidity, the second time shortening process (FIG. 20) was carried out for every 2,000 papers of printing operation.

### Comparison Example 2

In the comparison example 2, the first electrode condition setting process (FIGS. 10A and 10B) was not carried out and printing operation of 10,000 papers was carried out by applying bias voltage to the toner reallocation electrode 16Y under the environment of normal-temperature and humidity and high-temperature and humidity.

Results of the performance confirmation test 2 are as shown in the following table 4.

TABLE 4

| | | Swept-up | | Noise | |
|---|---|---|---|---|---|
| | Number of | Embodiment | Comp. | Embodiment | Comp. |
| Environment | prints | Ex. 2 | Ex. 2 | Ex. 2 | Ex. 2 |
| Normal- | 10,000 | ◯ | ◯ | ◯ | ◯ |
| temperature/ | prints | | | | |
| humidity | | | | | |
| High- | 10,000 | ◯ | X | ◯ | ◯ |
| temperature/ | prints | | | | |
| humidity | | | | | |

As for evaluation (◯/X evaluation), similarly to the performance confirmation test 1, ◯ evaluation is given when swept-up and noise are not visually recognized at all and X evaluation is given when swept-up and noise are visually recognized overall or partially.

As shown in table 4, swept-up and noise were not recognized in both the embodiment example 2 and the comparison example 2 under the environment of normal-temperature and humidity (◯ evaluation).

Under the environment of high-temperature and humidity, swept-up was not recognized in the embodiment example 2 (◯ evaluation), however, was recognized in the comparison example 2 (X evaluation).

Moreover, under the environment of high-temperature and humidity, noise was not recognized in both the embodiment example 2 and the comparison example 2 (◯ evaluation).

As described above, according to the embodiment, there is provided an image forming apparatus comprising a toner reallocation electrode to carry out a reallocation of a toner of a toner image by applying an electric field to the toner image developed on a latent image carrier which moves, a toner detection section to detect a toner amount of the toner image developed on the latent image carrier and a control section to calculate a toner amount adhered to the toner reallocation electrode or a density distribution of the toner image developed on the latent image carrier based on the toner amount detected by the toner detection section and to control an AC component of an applied voltage to be applied to the toner reallocation electrode based on the calculated toner amount or the calculated density distribution, and the control section decides a maximum value of the AC component of the applied voltage based on the toner amount or decides a minimum value of the AC component of the applied voltage based on the density distribution, and the control section controls the AC component within a control range of smaller than or equal to the decided maximum value or greater than or equal to the decided minimum value.

The AC bias value to be applied to the toner reallocation electrode 16Y can be decided so as to be within the proper range (O.W.). Therefore, swept-up and toner stain can be eliminated and deterioration of image quality can be prevented.

Preferably, the control section gradually increases a value of the applied voltage of the AC component and decides a value of the applied voltage of the AC component just before the toner amount exceeds a predetermined value as the maximum value, the control section gradually decreases the value of the applied voltage of the AC component and decides a value of the applied voltage of the AC component just before an amount of density change which is calculated from the density distribution exceeds a predetermined value as the minimum value, and the control section decides an intermediate value of the control range which is smaller than or equal to the decided maximum value and which is greater than or equal to the decided minimum value as a voltage value of the AC component to be applied to the toner reallocation electrode.

The intermediate value can be decided from the maximum value and the minimum value of the proper range (O.W.) and this intermediate value can be decided as the AC bias value. Because a value which does not easily fall out from the proper range can be decided as the AC bias value, the process for deciding the value over again does not need to be carried out for long period of time after once deciding the value.

Preferably, the control section gradually increases a value of the applied voltage of the AC component and decides a value of the applied voltage of the AC component just before the toner amount exceeds a predetermined value as the maximum value or the control section gradually decreases the value of the applied voltage of the AC component and decides a value of the applied voltage of the AC component just before an amount of density change which is calculated from the density distribution exceeds a predetermined value as the minimum value when a range of the control range is predetermined, and the control section decides a value which is obtained by subtracting a value at half of the range of the control range from the decided maximum value or a value which is obtained by adding the value at half of the range of the control range to the decided minimum value as a voltage value of the AC component to be applied to the toner reallocation electrode.

When the proper range (O.W.) is predetermined, a value close to the intermediate value can be calculated from either one of the maximum value or the minimum value of the proper range, and the calculated value can be decided as the AC bias value to be applied to the toner reallocation electrode 16Y. In this way, process time can be shortened comparing to the case where the intermediate value is decided after deciding both of the maximum value and the minimum value of the proper range.

Preferably, the control section gradually increases a value of the applied voltage of the AC component and decides a value of the applied voltage of the AC component just before the toner amount exceeds a predetermined value as the maximum value, and the control section decides the decided maximum value as a voltage value of the AC component to be applied to the toner reallocation electrode.

The maximum value of the proper range (O.W.) may be decided as the AC bias value to be applied to the toner reallocation electrode 16Y. This is effective under the environment where swept-up easily occurs (for example, the environment of high-temperature and humidity), and the effect of toner reallocation can be obtained sufficiently.

Preferably, the control section gradually decreases a value of the applied voltage of the AC component and decides a value of the applied voltage of the AC component just before an amount of density change which is calculated from the density distribution exceeds a predetermined value as the minimum value, and the control section decides the decided minimum value as a voltage value of the AC component to be applied to the toner reallocation electrode.

The minimum value of the proper range (O.W.) may be decided as the AC bias value to be applied to the toner reallocation electrode 16Y. This is effective under the environment where toner easily adheres to the toner reallocation electrode 16Y (for example, the environment of low-temperature and humidity).

Preferably, the image forming apparatus further comprises a temperature/humidity detection section to detect a temperature or a humidity, and the control section controls the AC component of the applied voltage to be applied to the toner reallocation electrode based on information of the temperature or the humidity detected by the temperature/humidity detection section.

Based on the information of temperature or humidity which is detected by the temperature/humidity detection section 44, the process to be used to decide the AC bias value can be selected among the first to the fourth electrode condition setting processes (FIGS. 10A and 10B and FIGS. 12, 14 and 16).

Preferably, the image forming apparatus further comprises a counting section to count number of prints, and the control section controls the AC component of the applied voltage to be applied to the toner reallocation electrode based on information of the number of prints counted by the counting section.

Based on the information of number of prints counted by the counting section 45, the process to be used to decide the AC bias value can be selected among the first to the fourth electrode condition setting processes.

Preferably, the image forming apparatus further comprises an average coverage calculation section to calculate an average coverage of a paper printed in a period between a predetermined previous print and an immediate print, and the control section controls the AC component of the applied voltage to be applied to the toner reallocation electrode based on information of the average coverage calculated by the average coverage calculation section.

Based on the information of average coverage calculated by the average coverage calculation section 46, the process to be used to decide the AC bias value can be selected among the first to the fourth electrode condition setting process.

Preferably, the image forming apparatus further comprises a cleaning pad to remove a toner adhered to the toner reallocation electrode.

By the cleaning pad 15Y, the toner adhered to the surface of the toner reallocation electrode 16Y can be removed.

Preferably, the control section changes a DC component of the applied voltage to be applied to the toner reallocation electrode when the toner adheres to the toner reallocation electrode.

By switching the DC bias to be applied to the toner reallocation electrode 16Y, the toner adhered to the toner reallocation electrode 16Y is removed by being blown to the photoreceptor 11Y.

### Second Embodiment

The most suitable structure and operation of the image forming apparatus and the image carrier unit according to the second embodiment will be described in detail with reference to the drawings.

In FIG. 1, a schematic diagram of the image forming apparatus 10 is shown. The structure and operation of each section are as already described, and therefore, the description is omitted here.

In FIG. 2, the image carrier unit 20 is shown. The structure and operation of each section are as already described, and therefore, the description is omitted here.

In FIG. 3, a schematic cross-sectional diagram of the IDC sensor 17Y is shown. The structure and operation of each section are as already described, and therefore, the description is omitted here.

In FIGS. 4 to 6, description diagrams of the detection method of toner stain on the toner reallocation electrode 16Y and the measuring method of swept-up amount are shown. The detection method of toner stain and the measuring method of swept-up amount are as already described, and therefore, the descriptions are omitted here.

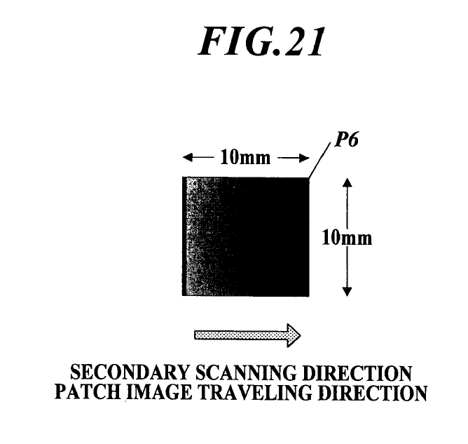

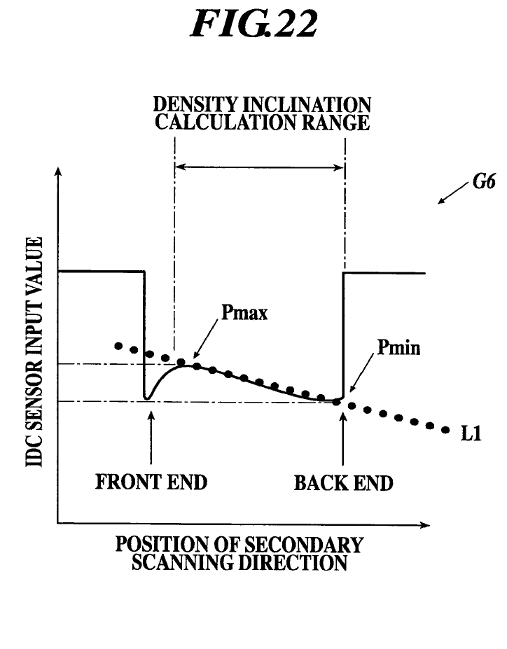

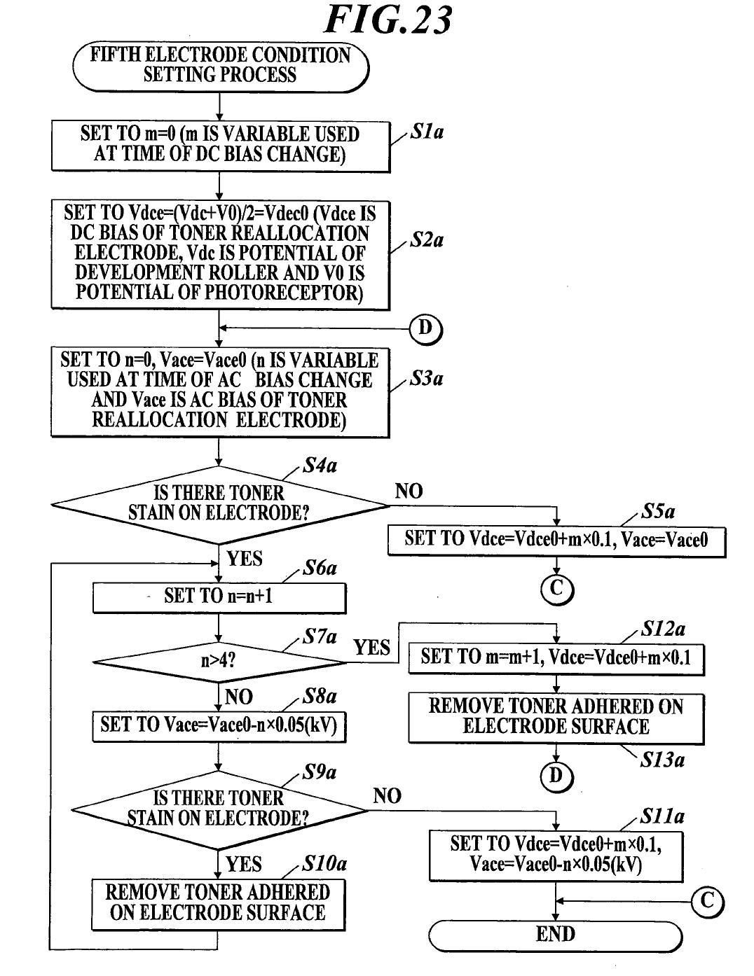

With reference to FIGS. 21 and 22, a detection method of density inclination will be described.

The detected density inclination is used as a criterion to determine whether there is a density inclination in a toner image or not in the after-mentioned electrode condition setting process (see FIGS. 23 to 25).

Density inclination is an amount of density change which changes from the front end to the back end in the secondary scanning direction (image traveling direction) of the patch image P6. In particular, density inclination is an absolute value of inclination of the straight line L1 which is after-mentioned in the description of FIG. 22.

The density inclination occurs when the electric field between the photoreceptor 11Y and the toner reallocation electrode 16Y is strong and when a great number of toner of the toner image formed on the photoreceptor 11Y moves to the toner reallocation electrode 16Y.

In FIG. 21, the patch image P6 is shown.

The patch image P6 is a toner image of 30% halftone of 10 mm×10 mm and is formed on the photoreceptor 11Y.

In FIG. 22, relation between input value of the IDC sensor 17Y and position in the secondary scanning direction is shown.

In graph G6 shown in FIG. 22, the vertical axis indicates input value [V] when the IDC sensor 17Y outputs an irradiation light and the reflection light of the irradiation light which is reflected on the photoreceptor 11Y is inputted.

Further, the horizontal axis indicates position in the secondary scanning direction including the area of the patch image P6.

The absolute value of the inclination of the straight line L1 in graph G6 is decided as the density inclination.

The straight line L1 is obtained by drawing an approximation line of input values from the point Pmax where the input value of the IDC sensor 17Y is maximum to the point Pmin where the input value of the IDC sensor 17Y is minimum in the area of patch image P6.

Moreover, when the condition of the following formula 2 is fulfilled, it can be determined that the density inclination has occurred.

<Formula 2>

(input value of IDC sensor 17Y at Pmax)−(input value of IDC sensor 17Y at Pmin)>0.3V (2)

With reference to FIG. 23, the fifth electrode condition setting process of the toner reallocation electrode 16Y will be described. In the fifth electrode condition setting process, a process of switching to the control of DC bias is carried out when the control of AC bias is carried out for a certain number of times or until a certain voltage value is obtained but the toner stain is not improved.

Hereinafter, a process which is carried out when the control of AC bias is carried out only for a certain number of times will be described.

The control section 42 sets the variable m so as to be m=0 to initialize (step S1a)

The variable m is a value which is used at the time of DC bias change.

The control section 42 sets the DC bias Vdce so as to be Vdce=(Vdc+V0)/2=Vdce0 to initialize (step S2a).

Vdce is DC bias to be applied to the toner reallocation electrode 16Y.

Vdc is a potential of the development roller 141Y and V0 is a potential of the photoreceptor 11Y.

The control section 42 sets the variable n so as to be n=0 and sets the AC bias Vace so as to be Vace=Vace0 to initialize (step S3a).

The variable n is a value which is used at the time of AC bias change. Vace is the AC bias to be applied to the toner reallocation electrode 16Y.

The control section 42 determines whether toner stain exists on the toner reallocation electrode 16Y or not (step S4a)

The criterion for determining the existence/non-existence of toner stain is as shown in the above described formula 1.

In step S4a, existence/non-existence of toner stain is used as the criterion. However, existence/non-existence of density inclination may be used as the criterion instead of existence/non-existence of toner stain. That is, in step S4a it may be said that “the control section 42 determines whether density inclination exists in a toner image developed on the photoreceptor 11Y or not”. In this case, the criterion for density inclination is as shown in the above described formula 2. Further, existence/non-existence of swept-up may be used as the criterion instead of existence/non-existence of density inclination for the determination in step S4a.

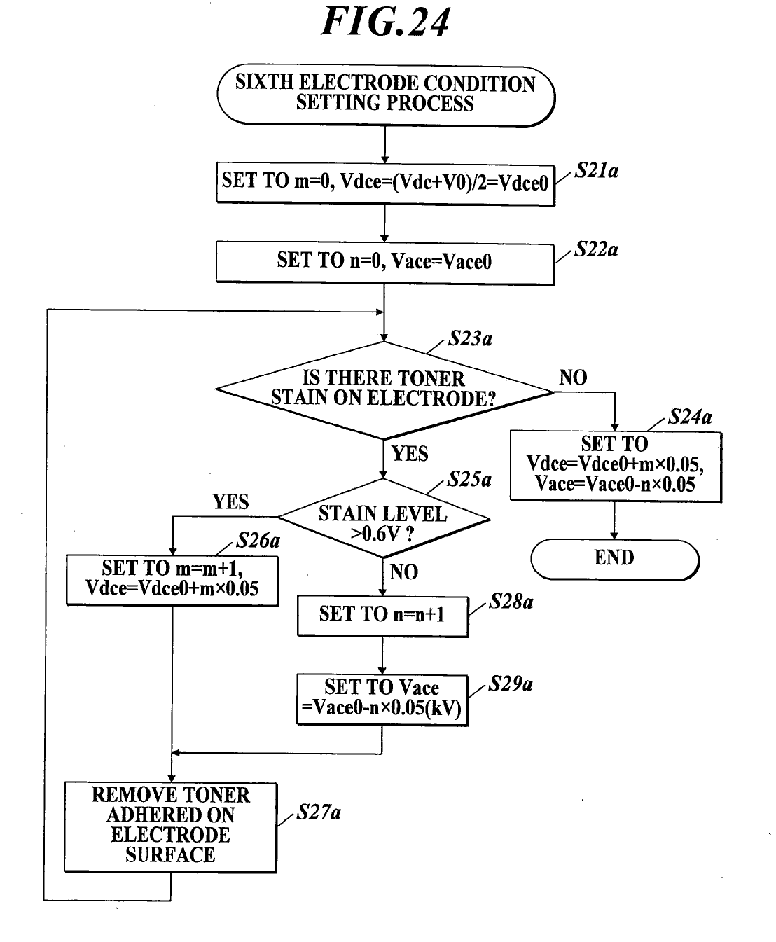

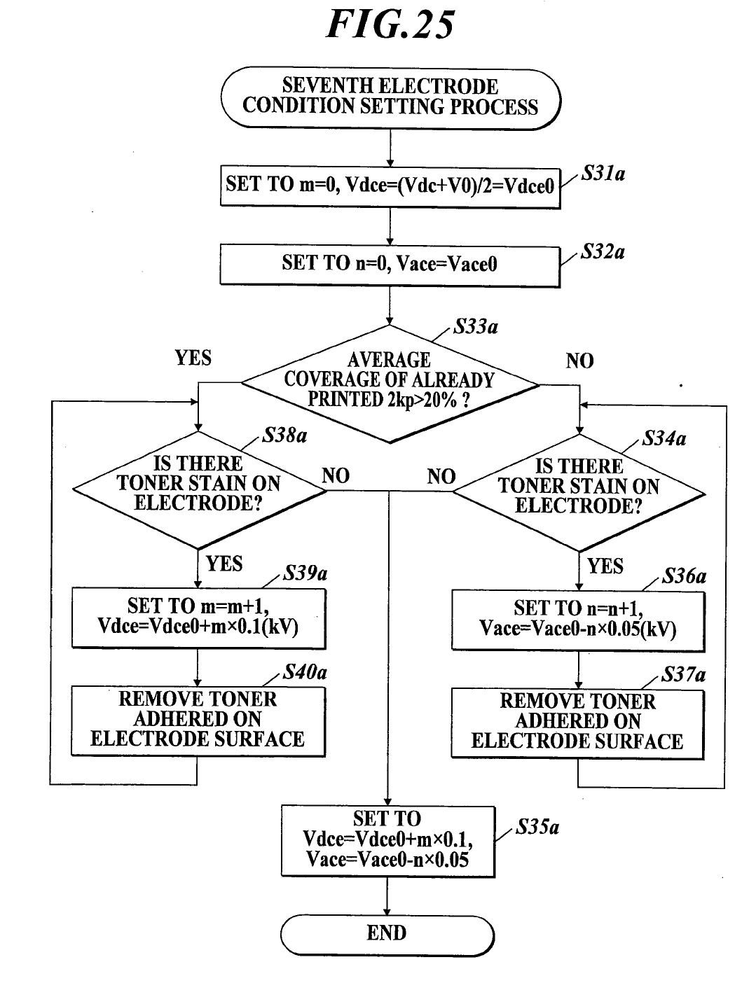

The above substitution of criterion can be similarly carried out in the present process (FIG. 23) and in other processes (FIGS. 24 and 25).

When toner stain does not exist (step S4; N), the control section 42 sets so as to be Vdce=Vdce0+m×0.1 and Vace=Vace0 (step S5a).

That is, because toner stain does not exist, the control section 42 leaves the DC bias value and the AC bias value to the initial values and finishes the present process.

When a toner stain exists (step S4a; Y), the control section 42 sets so as to be n=n+1 (step S6a).

The control section 42 determines whether the value of n is greater than 4 or not (step S7a).

The case where the value of n is greater than 4 means that it is a case where toner stain does not improve even when the AC bias is changed for three times. In contrary, the case where the value of n is smaller than 4 means it is a case where there is a possibility that toner stain will be improved when the AC bias is changed for about three times.

Here, “4” is used as a reference, however, the reference is not limited to this.

In the case where the value of n is smaller than 4 (step S7a; N), the control section 42 sets so as to be Vace=Vace0-n X0.05 and decreases the AC bias value (step S8a).

Here, as another control method, the control section 42 may control the duty ratio of a pulse wave of the bias voltage.

In particular, the control section 42 changes the duty ratio which is normally 50% to 70% for the pulse width in a period of time when toner moves to the toner reallocation electrode 16Y. Further, with the above, the AC bias which is normally 0.5 kV is reduced to 0.37 kV.

The control section 42 determines whether toner stain exists on the toner reallocation electrode 16Y or not (step S9a) This process is similar to step S4a.

When toner stain exists (step S9a; Y), the control section 42 removes the toner adhered to the surface of the toner reallocation electrode 16Y by using the cleaning pad 15Y (step S10a) and moves to step S6a.

Where toner stain does not exist (step S9a; N), the control section 42 sets so as to be Vdce=Vdce0+m×0.05 and Vace=Vace0−n×0.1. That is, the control section 42 makes the DC bias remain at the initial value and decreases the AC bias (step S11a), and the control section 42 finishes the present process.

Returning to step S4a, when the value of n is greater than 4 (step S7a; Y), the control section 42 sets so as to be m=m+1 and Vdce=Vdce0+m×0.1 (step S8a).

That is, the control section 42 determines that the toner stain cannot be improved even when the AC bias is decreased and the control section 42 carries out the process to increase the DC bias.

The control section 42 removes the toner adhered to the surface of the toner reallocation electrode 16Y (step S13a) and moves to step S3a.

After moving to step S3a, the control section 42 carries out the above described processes (see, steps S3a to S13a) and finishes the present process.

With reference to FIG. 24, the sixth electrode condition setting process will be described.

In the sixth electrode condition setting process, control of the AC bias or the DC bias is carried out based on the amount of toner stain or the amount of density inclination.

Hereinafter, a case where the control is carried out based on the amount of toner stain will be described.

The control section 42 sets the variable m so as to be m=0 and sets the DC bias Vdce so as to be Vdce=(Vdc+V0)/2=Vdce0 to initialize (step S21a).

As described in FIG. 23, the variable m is a value which is to be used at the time of DC bias change, Vdce is DC bias, Vdc is a potential of the development roller 141Y and V0 is a potential of the photoreceptor 11Y.

The control section 42 sets the variable n so as to be n=0 and sets AC bias Vace so as to be Vace=Vace0 to initialize (step S22a).

As described in FIG. 23, the variable n is a value which is to be used at the time of AC bias change and Vace is the AC bias.

The control section 42 determines whether toner stain exists on the toner reallocation electrode 16Y or not (step S23a).

The criterion for existence/non-existence of toner stain is as shown in the above formula 1 and is calculated by the formula of “(input value of IDC sensor 17Y when bias voltage is ON)−(input value of IDC sensor 17Y when bias voltage is OFF)≧0.25V (1)”.

When toner stain does not exist (step S23a; N), the control section 42 sets so as to be Vdce=Vdce0+m×0.05 and Vace=Vace0−n×0.05 (step S24a) and finishes the present process.

When toner stain exists (step S23a; Y), the control section 42 determines whether the stain level which is calculated by the above formula 1 is 0.6V or greater or not (step S25a).

When the stain level is greater than 0.6V (step S25a; Y), the control section 42 sets so as to be m=m+1 and Vdce=Vdce0+m×0.05 (step S26a).

That is, the control section 42 determines that the toner stain cannot be improved even when the AC bias is decreased and the control section 42 carries out the process to increase the DC bias.

The control section 42 removes the toner adhered to the surface of the toner reallocation electrode 16Y (step S27a) and moves to step S23a.

The control section 42 determines whether toner stain exists on the toner reallocation electrode 16Y or not again (step S23a) and finishes the present process via step S24a when toner stain does not exist.

Returning to step S25a, when the stain level is not greater than 0.6V (step S25a), the control section 42 sets so as to be n=n+1 (step S28a).

The control section 42 sets so as to be Vace=Vace0−n×0.05 (step S29a) and moves to step S27a.

Here, as another control method, the control section 42 may control the duty ratio of a pulse wave of the bias voltage. The particular control is similar to the control described in the description of step S8a of FIG. 23, and therefore, the description is omitted here.

After moving to step S27a, the control section 42 determines whether toner stain exists on the toner reallocation electrode 16Y or not again (step S23a) and finishes the present process via step S24a when toner stain does not exist.

With reference to FIG. 25, the seventh electrode condition setting process will be described.

In the seventh electrode condition setting process, control of the AC bias or the DC bias is carried out based on an average coverage of papers which were printed in a period between a predetermined previous print and the immediate print.

The control section 42 sets the variable m so as to be m=0 and sets the DC bias Vdce so as to be Vdce=(Vdc+V0)/2=Vdce0 to initialize (step S31a).

The control section 42 sets the variable n so as to be n=0 and sets the AC bias Vace so as to be Vace=Vace0 to initialize (step S32a).

As form, Vdce, Vdc, V0, n and Vace, the values are similar to the values described in FIGS. 23 and 24, and therefore, the description is omitted here.

The control section 42 determines whether the average coverage of already printed 2,000 papers which are printed before the present process is greater than 20% or not (step S33a).

Here, “20%” is used as a reference here, however, the reference is not limited to this.

The case where the average coverage is greater than 20% is a case where a great amount of toner is being used and new toner which has great amount of external additives on surface thereof is being supplied. This kind of toner has a weak adhesion to the photoreceptor 11Y and easily moves by the electric field and tends to generate stain on the toner reallocation electrode 16Y.

In the case where the average coverage is not greater than 20% (step S33a; N), the control section 42 determines whether toner stain exists on the toner reallocation electrode 16Y or not (step S34a).

When toner stain does not exist (step S34a; N), the control section 42 sets so as to be Vdce=Vdce0+m×0.1 and Vace=Vace0−n×0.05 (step S35a) and finishes the present process.

When toner stain exists (step S34a; Y), the control section 42 sets so as to be n=n+1 and Vace=Vace0−n×0.05 (step S36a).

Here, as another control method, the control section 42 may control the duty ration of a pulse wave of the bias voltage. The particular control is similar to the description given in the description of step S8a of FIG. 23, and therefore, the description is omitted here.

The control section 42 removes the toner adhered to the surface of the toner reallocation electrode 16Y (step S37a) and moves to step S34a.

After moving to step S34a, the control section 42 finishes the present process via step S35a when toner stain doest not exist.

Returning to step S33a, when the average coverage is greater than 20% (step S33a; Y), the control section 42 determines whether toner stain exists on the toner reallocation electrode 16Y or not (step S38a).

When toner stain does not exist (step S38a; N), the control section 42 finishes the present process via step S35a.

When toner stain exists (step S38a; Y), the control section 42 sets so as to be m=m+1 and Vdce=Vdce0+m×0.1 (step S39a).

The control section 42 removes the toner adhered to the surface of the toner reallocation electrode 16Y (step S40a) and moves to step S38a.

After moving to step S38a, the control section 42 finishes the present process via step S35a when toner stain does not exist.

With reference to tables 11 and 12, the performance confirmation test will be described.

The common conditions of the embodiment example and the comparison example in the performance confirmation test are shown in the following table 11.

TABLE 11

| | |
|---|---|
| Environment: | normal-temperature and humidity |
| | (temperature: 20° C., |
| | humidity: 50%) |
| Diameter of photoreceptor: | 60 mm |
| Diameter of development roller: | 25 mm |
| Surface speed of development roller: | 720 mm |
| | (reverse rotation development) |
| Distance between development | 0.3 mm |
| roller and photoreceptor: | |
| Transport amount of developer | 220 g/m² |
| on development roller: | |
| Image forming apparatus: | black and white 80 ppm |
| Process speed: | 400 mm/s |
| Diameter of toner: | 6.5 μm |
| Diameter of carrier: | 33 μm |
| Density of toner: | 7 wt % |
| Amount of developer in | 1000 g |
| development device: | |
| Condition of toner reallocation | DC bias = −600 V |
| electrode at time of test start: | AC bias = 2.5 kV, f = 9 kHz, |
| | gap = 0.3 mm |
| Patch image: | Line screen of 200lpi at 600dpi |
| | Density data = 180/255 |

### Embodiment Example

In the embodiment example, the electrode condition setting process which is described in FIGS. 23 to 25 is carried out for every 1,000 papers of printing, and the voltage applied to the toner reallocation electrode 16Y until 5,000 papers are printed was controlled.

The performance confirmation test was carried out in two patterns which are a case where the average coverage of the already printed 5,000 papers is made to be 5% (test 1) and a case where the average coverage of the already printed 5,000 papers is made to be 30% (test 2).

### Comparison Example

In the comparison example, the voltage applied to the toner reallocation electrode 16Y was not controlled until 5,000 papers were printed.

Similarly to the above described embodiment example, the performance confirmation test was carried out in two patterns of test 1 and test 2.

Results of the performance confirmation test are as shown in the following table 12.

TABLE 12

| | | | Swept-up | | Noise | |
|---|---|---|---|---|---|---|
| | | Number of | Embodiment | Comp. | Embodiment | Comp. |
| Test | Coverage | prints | Ex. | Ex. | Ex. | Ex. |
| 1 | 5% | 5,000 | ◯ | ◯ | ◯ | ◯ |
| 2 | 30% | 5,000 | ◯ | X | ◯ | X |

As shown in table 12, in the case of low coverage printing of test 1, swept-up and noise were not recognized in an image formed on a paper in both embodiment example and the comparison example (◯ evaluation).

Here, when swept-up and noise were visually recognized partially or overall, it is evaluated that swept-up or noise exists (X evaluation) and when swept-up or noise are not visually recognized at all, it is evaluated the swept-up or noise does not exist (◯ evaluation).

In the case of high coverage printing of test 2, swept-up and noise were not recognized in an image formed on a paper in the embodiment example (◯ evaluation).

On the other hand, swept-up and noise were recognized in an image formed on a paper in the comparison example (X evaluation).

As described above, according to the embodiment, there is provided an image forming apparatus comprising a toner reallocation electrode to carry out a reallocation of a toner of a toner image by applying an electric field to the toner image developed on a latent image carrier which moves, a toner detection section to detect a toner amount of the toner image developed on the latent image carrier and a control section to calculate a toner amount adhered to the toner reallocation electrode or a density distribution of the toner image developed on the latent image carrier based on the toner amount detected by the toner detection section and to control an AC component or a DC component of an applied voltage to be applied to the toner reallocation electrode based on the calculated toner amount or the calculated density distribution.

Based on the amount of toner (toner stain) adhered to the toner reallocation electrode 16Y or the density distribution (density inclination or swept-up) of the toner image developed on the photoreceptor 11Y, the AC bias or the DC bias of the applied voltage to be applied to the toner reallocation electrode 16Y can be effectively controlled. AS a result, deterioration of image quality can be prevented.

Preferably, the control section controls the AC component of the applied voltage for only a predetermined number of times based on the calculated toner amount or the calculated density distribution, and the control section controls the DC component of the applied voltage when the toner adheres to the toner reallocation electrode even after the AC component has been controlled for only the predetermined number of times.

The AC bias can be controlled for a predetermined number of times, and the DC bias can be controlled when it is determined that the toner stain cannot be improve with the control of AC bias. Because the object to be control can be effectively switched, the control time can be shortened and deterioration of image quality can be prevented.

Preferably, the control section controls the AC component of the applied voltage for only a predetermined voltage value based on the calculated toner amount and the calculated density distribution, and the control section controls the DC component of the applied voltage when the toner adheres to the toner reallocation electrode even after the AC component has been controlled only for the predetermined voltage value.

The AC bias can be controlled only for a predetermined voltage value, and the DC bias can be controlled when it is determined that the toner stain cannot be improved with the control of AC bias. Because the object to be controlled can be effectively switched, the control time can be shortened and deterioration of image quality can be prevented.

Preferably, the control section determines whether the toner amount adhered to the toner reallocation electrode is greater than a predetermined value or not based on the calculated toner amount, and the control section controls the AC component of the applied voltage when the toner amount is not greater than the predetermined number and controls the DC component of the applied voltage when the toner amount is greater than the predetermine value.

It can be switched so as to control the AC bias when the toner stain adhered on the toner reallocation electrode 16Y is not greater than a predetermined value and so as to control the DC bias when the toner stain is greater than the predetermined value. Because the object to be controlled is effectively switched, the control time can be shortened and deterioration of image quality can be prevented.

Preferably, the control section determines whether a density inclination or a swept-up amount in the toner image developed on the latent image carrier is greater than a predetermined value or not based on the calculated density distribution, and the control section controls the AC component of the applied voltage when the density inclination or the swept-up amount is not greater than the predetermined value and controls the DC component of the applied voltage when the density inclination or the swept-up amount is greater than the predetermined value.

It can be switched so as to control the AC bias when the density inclination or swept-up amount of a toner image which is developed on the photoreceptor 11Y is not greater than a predetermined value and so as to control the DC bias when the density inclination or swept-up amount of the toner image is greater than the predetermined value. Because the object to be controlled is effectively switched, the control time can be shortened and deterioration of image quality can be prevented.

Preferably, the control section calculates an average coverage of a paper printed in a period between a predetermined previous print and an immediate print, and the control section controls the AC component or the DC component of the applied voltage based on the calculated average coverage.

It can be switched so as to control the AC bias when the average coverage of the papers which were printed in a period between a predetermined previous print and the immediate print is not greater than a predetermined value and so as to control the DC bias when the average coverage is greater than the predetermined value. Because the object to be controlled is effectively switched, the control time can be shortened and deterioration of image quality can be prevented.

Preferably, the control section controls a duty ration of a pulse wave in the applied voltage.

When toner stain occurred, duty ratio of the pulse wave of the bias voltage may be compared. In such way, toner will not easily move to the toner reallocation electrode 16Y, and occurrence of toner stain can be prevented.

Preferably, the image forming apparatus further comprises a toner removing section to remove the toner adhered to the toner reallocation electrode.

By being provided with the cleaning pad 15Y which removes the toner adhered to the toner reallocation electrode 16Y, deterioration of image quality can be prevented.

The present U.S. patent application claims a priority under the Paris Convention of Japanese patent application No. 2009-100651 filed on Apr. 17, 2009 and Japanese patent application No. 2009-102646 filed on Apr. 21, 2009, which shall be a basis of correction of an incorrect translation.

What is claimed is:

1. An image forming apparatus, comprising:
a toner reallocation electrode to carry out a reallocation of a toner of a toner image by applying an electric field to the toner image developed on a latent image carrier which moves;
a toner detection section to detect a toner amount of the toner image developed on the latent image carrier; and
a control section to calculate a toner amount adhered to the toner reallocation electrode or a density distribution of the toner image developed on the latent image carrier based on the toner amount detected by the toner detection section and to control an AC component of an applied voltage to be applied to the toner reallocation electrode based on the calculated toner amount or the calculated density distribution,
wherein
the control section decides a maximum value of the AC component of the applied voltage based on the toner amount or decides a minimum value of the AC component of the applied voltage based on the density distribution, and the control section controls the AC component within a control range of smaller than or equal to the decided maximum value or greater than or equal to the decided minimum value.

2. The image forming apparatus of claim 1, wherein
the control section gradually increases a value of the applied voltage of the AC component and decides a value of the applied voltage of the AC component just before the toner amount exceeds a predetermined value as the maximum value, the control section gradually decreases the value of the applied voltage of the AC component and decides a value of the applied voltage of the AC component just before an amount of density change which is calculated from the density distribution exceeds a predetermined value as the minimum value, and the control section decides an intermediate value of the control range which is smaller than or equal to the decided maximum value and which is greater than or equal to the decided minimum value as a voltage value of the AC component to be applied to the toner reallocation electrode.

3. The image forming apparatus of claim 1, wherein
the control section gradually increases a value of the applied voltage of the AC component and decides a value of the applied voltage of the AC component just before the toner amount exceeds a predetermined value as the maximum value or the control section gradually decreases the value of the applied voltage of the AC component and decides a value of the applied voltage of the AC component just before an amount of density change which is calculated from the density distribution exceeds a predetermined value as the minimum value when a range of the control range is predetermined, and the control section decides a value which is obtained by subtracting a value at half of the range of the control range from the decided maximum value or a value which is obtained by adding the value at half of the range of the control range to the decided minimum value as a voltage value of the AC component to be applied to the toner reallocation electrode.

4. The image forming apparatus of claim 1, wherein
the control section gradually increases a value of the applied voltage of the AC component and decides a value of the applied voltage of the AC component just before the toner amount exceeds a predetermined value as the maximum value, and the control section decides the decided maximum value as a voltage value of the AC component to be applied to the toner reallocation electrode.

5. The image forming apparatus of claim 1, wherein
the control section gradually decreases a value of the applied voltage of the AC component and decides a value of the applied voltage of the AC component just before an amount of density change which is calculated from the density distribution exceeds a predetermined value as the minimum value, and the control section decides the decided minimum value as a voltage value of the AC component to be applied to the toner reallocation electrode.

6. The image forming apparatus of claim 1, further comprising a temperature/humidity detection section to detect a temperature or a humidity, wherein
the control section controls the AC component of the applied voltage to be applied to the toner reallocation electrode based on information of the temperature or the humidity detected by the temperature/humidity detection section.

7. The image forming apparatus of claim 1, further comprising a counting section to count number of prints, wherein
the control section controls the AC component of the applied voltage to be applied to the toner reallocation electrode based on information of the number of prints counted by the counting section.

8. The image forming apparatus of claim 1, further comprising an average coverage calculation section to calculate an average coverage of a paper printed in a period between a predetermined previous print and an immediate print, wherein
the control section controls the AC component of the applied voltage to be applied to the toner reallocation electrode based on information of the average coverage calculated by the average coverage calculation section.

9. The image forming apparatus of claim 1, further comprising a cleaning pad to remove a toner adhered to the toner reallocation electrode.

10. The image forming apparatus of claim 1, wherein
the control section changes a DC component of the applied voltage to be applied to the toner reallocation electrode when the toner adheres to the toner reallocation electrode.

11. An image forming apparatus, comprising:
a toner reallocation electrode to carry out a reallocation of a toner of a toner image by applying an electric field to the toner image developed on a latent image carrier which moves;
a toner detection section to detect a toner amount of the toner image developed on the latent image carrier; and
a control section to calculate a toner amount adhered to the toner reallocation electrode or a density distribution of the toner image developed on the latent image carrier based on the toner amount detected by the toner detection section and to control an AC component or a DC component of an applied voltage to be applied to the toner reallocation electrode based on the calculated toner amount or the calculated density distribution.

12. The image forming apparatus of claim 11, wherein
the control section controls the AC component of the applied voltage for only a predetermined number of times based on the calculated toner amount or the calculated density distribution, and the control section controls the DC component of the applied voltage when the toner adheres to the toner reallocation electrode even after the AC component has been controlled for only the predetermined number of times.

13. The image forming apparatus of claim 11, wherein
the control section controls the AC component of the applied voltage for only a predetermined voltage value based on the calculated toner amount and the calculated density distribution, and the control section controls the DC component of the applied voltage when the toner adheres to the toner reallocation electrode even after the AC component has been controlled only for the predetermined voltage value.

14. The image forming apparatus of claim 11, wherein
the control section determines whether the toner amount adhered to the toner reallocation electrode is greater than a predetermined value or not based on the calculated toner amount, and the control section controls the AC component of the applied voltage when the toner amount is not greater than the predetermined number and controls the DC component of the applied voltage when the toner amount is greater than the predetermine value.

15. The image forming apparatus of claim 11, wherein
the control section determines whether a density inclination or a swept-up amount in the toner image developed on the latent image carrier is greater than a predetermined value or not based on the calculated density distribution, and the control section controls the AC component of the applied voltage when the density inclination or the swept-up amount is not greater than the predetermined value and controls the DC component of the applied voltage when the density inclination or the swept-up amount is greater than the predetermined value.

16. The image forming apparatus of claim 11, wherein
the control section calculates an average coverage of a paper printed in a period between a predetermined previous print and an immediate print, and the control section controls the AC component or the DC component of the applied voltage based on the calculated average coverage.

17. The image forming apparatus of claim 11, wherein
the control section controls a duty ration of a pulse wave in the applied voltage.

18. The image forming apparatus of claim 11, further comprising a toner removing section to remove the toner adhered to the toner reallocation electrode.

19. An image carrier unit, comprising an image carrier to support a toner image, a toner reallocation electrode to carry out a reallocation of a toner of the toner image and a toner detection section to detect a toner amount of the toner image so as to be housed in a same casing, wherein
the toner reallocation electrode is connected to a voltage applying device which is provided outside of the casing, and
the toner detection section is connected to a control section which is provided outside of the casing.

20. The image carrier unit of claim 19, further comprising a toner removing section to remove a toner adhered to the toner reallocation electrode.
